(19) United States
(12) Patent Application Publication
(10) Pub. No.: US 2026/0270821 A1
(43) Pub. Date: Sep. 10, 2026

(54) METHOD AND APPARATUS FOR CONFIGURING AND APPLYING CANDIDATE CELL

(71) Applicant: 1FINITY Inc., Kawasaki-shi (JP)

(72) Inventors: Meiyi JIA, Beijing (CN); Guorong LI, Beijing (CN); Su YI, Beijing (CN)

(73) Assignee: 1FINITY Inc., Kawasaki-shi (JP)

(21) Appl. No.: 19/663,334

(22) Filed: Apr. 30, 2026

Related U.S. Application Data
(63) Continuation of application No. PCT/CN2023/129458, filed on Nov. 2, 2023.

(51) Int. Cl. H04W 36/04; H04W 36/00; H04W 36/36; H04W 56/00; H04W 76/20

(52) U.S. Cl. CPC H04W 36/04; H04W 36/0079; H04W 36/362; H04W 56/0015; H04W 76/20

(57) ABSTRACT

A method and an apparatus for configuring and applying candidate cell, the method comprising: receiving, by a terminal equipment, configuration information for configuring candidate cell(s) transmitted by a network device, wherein one cell is not simultaneously configured as a conditional handover (CHO) candidate cell and an L1/L2 Triggered Mobility (LTM) candidate cell.

### CROSS-REFERENCE TO RELATED APPLICATION

This application is a continuation application under 35 U.S.C. 111 (a) of International Patent Application PCT/CN2023/129458 filed on Nov. 2, 2023, and designated the U.S., the entire contents of which are incorporated herein by reference.

### TECHNICAL FIELD

Embodiments of the present disclosure relate to the technical field of communications.

### BACKGROUND

Network-controlled mobility is applicable to terminal equipments in a connected state, and may be divided into two types of mobility: cell-level mobility and beam-level mobility. Cell-level mobility requires explicit Radio Resource Control (RRC) signaling to trigger, i.e., a handover is triggered by RRC.

A handover mechanism triggered by RRC requires a terminal equipment at least to reset a Media Access Control (MAC) entity and re-establish Radio Link Control (RLC). RRC-managed handovers with Packet Data Convergence Protocol (PDCP) entity reestablishment and without PDCP entity reestablishment are supported.

For data radio bearers (DRBs) using an RLC AM (acknowledged mode), a PDCP may be re-established together with a security key change, or initiate a data recovery procedure without a key change. For DRBs using an RLC UM (unacknowledged mode), a PDCP may be re-established together with a security key change, or remain as it is without a key change. For signaling radio bearers (SRBs), a PDCP may remain as it is and discard stored PDCP PDUs/SDUs without a key change, or be re-established together with a security key change.

Serving cells may be changed via Layer 1 (L1)/Layer 2 (L2) signaling. FIG. 1 is an exemplary diagram of a scenario of L1/L2-based inter-cell mobility. As shown in FIG. 1, when a terminal equipment moves from a coverage area of one cell to a coverage area of another cell, serving cell switch needs to be performed at a certain point.

Currently, serving cell switch is triggered by Layer 3 (L3) measurements and completed by RRC signaling, Reconfiguration with Synchronisation is triggered for PCell and PSCell switch, and release of SCells when applicable is added. In all cases, full L2 (and L1) reset is involved, resulting in longer latency, greater overhead, and longer interruption time compared to beam handover mobility.

A goal of L1/L2 mobility enhancements is to ensure serving cell switch via L1/L2 signaling, so as to reduce latency, overhead, and interruption time. To reduce mobility latency, a mechanism and a procedure for L1/L2-based inter-cell mobility may include: configuration and maintenance of a plurality of candidate cells to allow for rapid application of configuration of candidate cells; for potentially applicable scenarios, a dynamic handover mechanism between candidate serving cells (including special cells and secondary cells) based on L1/L2 signaling; L1 enhancements for inter-cell beam management, including L1 measurement and reporting, and beam indication; Timing Advance (TA) management; CU-DU interface signaling to support L1/L2 mobility.

It should be noted that the above introduction to the technical background is just to facilitate a clear and complete description of technical solutions of the present disclosure, and is elaborated to facilitate understanding of persons skilled in the art. It cannot be considered that the technical solutions are known by persons skilled in the art just because these solutions are elaborated in Background of the present disclosure.

### SUMMARY

Inventors find that currently, a network device may configure a CHO candidate cell or an LTM candidate cell for a terminal equipment, to support performing Conditional Handover (CHO) or L1/L2 Triggered Mobility (LTM) operations. However, when one cell is configured as both a CHO candidate cell and an LTM candidate cell, a terminal equipment is unable to determine whether to attempt CHO execution once or attempt LTM execution once. In this way, a terminal equipment might be unable to apply fast failure recovery, leading to longer interruption time.

For at least one of the above problems, embodiments of the present disclosure provide a method and an apparatus for configuring and applying candidate cell(s).

According to one aspect of embodiments of the present disclosure, a method for configuring candidate cell(s) is provided, including that:
a terminal equipment receives configuration information for configuring candidate cell(s) transmitted by a network device;
wherein one cell is not simultaneously configured as a Conditional Handover (CHO) candidate cell and an L1/L2 Triggered Mobility (LTM) candidate cell of the terminal equipment.

According to another aspect of embodiments of the present disclosure, an apparatus for configuring candidate cell(s) is provided, including:
a receiving unit configured to receive configuration information for configuring candidate cell(s) transmitted by a network device;
wherein one cell is not simultaneously configured as a Conditional Handover (CHO) candidate cell and an L1/L2 Triggered Mobility (LTM) candidate cell of a terminal equipment.

According to another aspect of embodiments of the present disclosure, a method for applying candidate cell(s) is provided, including that:
a terminal equipment receives configuration information for configuring candidate cell(s) transmitted by a network device; and
the terminal equipment attempts to execute CHO or LTM according to regulations or based on implementation of a terminal equipment or according to a configuration of a network device.

According to another aspect of embodiments of the present disclosure, an apparatus for applying candidate cell(s) is provided, including:
a receiving unit configured to receive configuration information for configuring candidate cell(s) transmitted by a network device; and
a processing unit configured to attempt to execute CHO or LTM according to regulations or based on implementation of a terminal equipment or according to a configuration of a network device.

According to another aspect of embodiments of the present disclosure, a method for configuring candidate cell(s) is provided, including that:
a network device transmits configuration information for configuring candidate cell(s) to a terminal equipment;
wherein one cell is not simultaneously configured as a Conditional Handover (CHO) candidate cell and an L1/L2 Triggered Mobility (LTM) candidate cell of the terminal equipment, or, the terminal equipment attempts to execute CHO or LTM according to a configuration of the network device.

According to another aspect of embodiments of the present disclosure, an apparatus for configuring candidate cell(s) is provided, including:
a transmitting unit configured to transmit configuration information for configuring candidate cell(s) to a terminal equipment;
wherein one cell is not simultaneously configured as a Conditional Handover (CHO) candidate cell and an L1/L2 Triggered Mobility (LTM) candidate cell of the terminal equipment, or, the terminal equipment attempts to execute CHO or LTM according to a configuration of the network device.

One of advantageous effects of embodiments of the present disclosure lies in that a terminal equipment is able to determine to attempt CHO execution once or attempt LTM execution once, so that the terminal equipment is able to apply fast failure recovery in case of a handover failure or a radio link failure or an LTM failure, thereby reducing interruption time.

Referring to later descriptions and drawings, specific implementations of the present disclosure are disclosed in detail, indicating modes in which principles of the present disclosure may be adopted. It should be understood that implementations of the present disclosure are not limited in terms of a scope. Within scopes of terms of attached claims, implementations of the present disclosure include many changes, modifications, and equivalents.

Features described and/or shown for one implementation may be used in the same way or in a similar way in one or more other implementations, and may be combined with or replace features in other implementations.

It should be emphasized that term “include/comprise” when being used herein refers to presence of a feature, a whole piece, a step, or a component, but does not exclude presence or addition of one or more other features, whole pieces, steps, or components.

### BRIEF DESCRIPTION OF DRAWINGS

Element(s) and feature(s) described in one drawing or one implementation of embodiments of the present disclosure may be combined with element(s) and feature(s) shown in one or more other drawings or implementations. In addition, in the drawings, similar reference signs denote corresponding components in several drawings and may be used to indicate corresponding components used in more than one implementation.

FIG. 1 is an exemplary diagram of a scenario of L1/L2-based inter-cell mobility;

FIG. 2 is a schematic diagram of a communication system in embodiments of the present disclosure;

FIG. 3 is a schematic diagram of a signaling procedure of LTM;

FIG. 4 is a schematic diagram of a failure recovery procedure;

FIG. 5 is a schematic diagram of a method for configuring candidate cell(s) in embodiments of the present disclosure;

FIG. 6 is a schematic diagram of a method for applying candidate cell(s) in embodiments of the present disclosure;

FIG. 7 is a schematic diagram of failure recovery in embodiments of the present disclosure;

FIG. 8 is a schematic diagram of a method for configuring candidate cell(s) in embodiments of the present disclosure;

FIG. 9 is a schematic diagram of an apparatus for configuring or applying candidate cell(s) in embodiments of the present disclosure;

FIG. 10 is a schematic diagram of an apparatus for configuring candidate cell(s) in embodiments of the present disclosure;

FIG. 11 is a schematic diagram of a network device in embodiments of the present disclosure;

FIG. 12 is a schematic diagram of a terminal equipment in embodiments of the present disclosure.

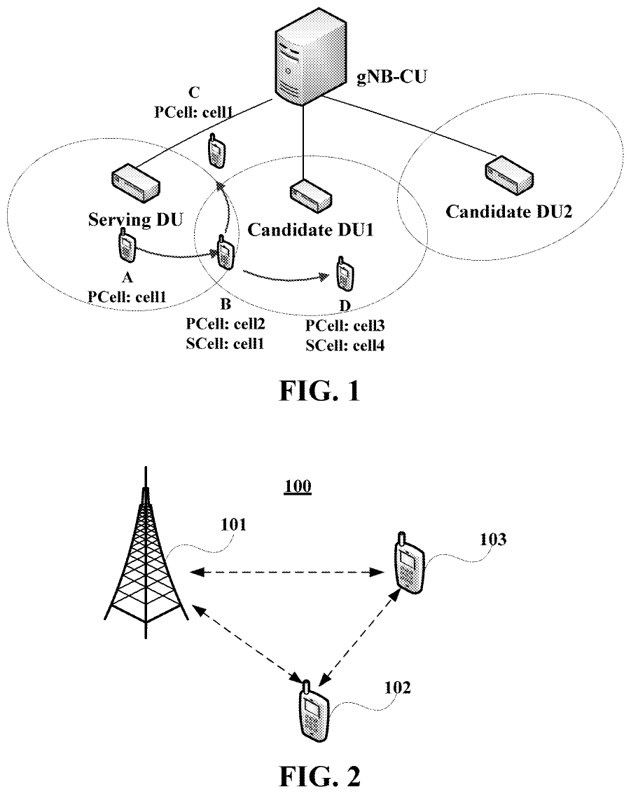

### DETAILED DESCRIPTION

Referring to the drawings, through the following Specification, the aforementioned and other features in the present disclosure will become obvious. The Specification and the drawings specifically disclose specific implementations of the present disclosure, indicating partial implementations for which a principle of the present disclosure may be adopted. It should be understood that the present disclosure is not limited to described implementations, on the contrary, the present disclosure includes all modifications, variations and equivalents falling within scopes of attached claims.

In embodiments of the present disclosure, terms “first” and “second”, etc. are used to distinguish different elements in terms of appellation, but do not represent a spatial arrangement or time sequence, etc. of these elements, and these elements should not be limited by these terms. Term “and/or” includes any one of and all combinations of one or more of terms listed in an associated manner. Terms “contain”, “include” and “have”, etc. refer to presence of stated feature(s), element(s), component(s), or assembly/assemblies, but do not exclude presence or addition of one or more other features, elements, components, or assemblies.

In embodiments of the present disclosure, singular forms “a/an” and “the”, etc. include plural forms, and should be understood broadly as “a kind of” or “a type of”, but are not defined as the meaning of “one”, in addition, term “the” should be understood to include both singular forms and plural forms, unless the context clearly indicates otherwise. In addition, term “according to” should be understood as “at least partially according to . . . ”, and term “based on” should be understood as “at least partially based on . . . ”, unless the context clearly indicates otherwise.

In embodiments of the present disclosure, term “communication network” or “radio communication network” may refer to a network meeting any of the following communication standards, such as Long Term Evolution (LTE), LTE-Advanced (LTE-A), Wideband Code Division Multiple Access (WCDMA), High-Speed Packet Access (HSPA) and so on.

And, communication between devices in a communication system may be performed according to a communication protocol at any stage, for example which may include but be not limited to the following communication protocols: 1G (generation), 2G, 2.5G, 2.75G, 3G, 4G, 4.5G, and 5G, New Radio (NR), future 6G and so on, and/or other communication protocols that are currently known or will be developed in the future.

In embodiments of the present disclosure, term “network device” e.g. refers to a device accessing a terminal equipment to a communication network in a communication system and providing services to the terminal equipment. Network device may include but be not limited to the following devices: a Base Station (BS), an Access Point (AP), a Transmission Reception Point (TRP), a broadcast transmitter, a Mobile Management Entity (MME), a gateway, a server, a Radio Network Controller (RNC), a Base Station Controller (BSC) and so on.

Base station may include but be not limited to: a node B (NodeB or NB), an evolution node B (eNodeB or eNB), a 5G base station (gNB) and an IAB donor, etc., moreover, may further include a Remote Radio Head (RRH), a Remote Radio Unit (RRU), a relay or a low power node (such as femeto, pico, etc.). And term “base station” may include some or all functions thereof, and each base station may provide communication coverage to a specific geographic region. Term “cell” may refer to a base station and/or a coverage area thereof, which depends on a context in which this term is used.

In embodiments of the present disclosure, term “User Equipment (UE)” or “Terminal Equipment (TE) or Terminal Device” refers to e.g. a device accessing a communication network and receiving network services via a network device. Terminal equipment may be fixed or mobile, and may also be called a Mobile Station (MS), a terminal, a Subscriber Station (SS), an Access Terminal (AT) and a station and so on.

Terminal equipment may include but be not limited to the following devices: a Cellular Phone, a Personal Digital Assistant (PDA), a wireless modem, a wireless communication device, a handheld device, a machine-type communication device, a laptop computer, a cordless phone, a smart phone, a smart watch, a digital camera and so on.

For another example, under a scenario such as Internet of Things (IoT), a terminal equipment may further be a machine or an apparatus for monitoring or measurement, for example may include but be not limited to: a Machine Type Communication (MTC) terminal, a vehicle-mounted communication terminal, a Device to Device (D2D) terminal, a Machine to Machine (M2M) terminal and so on.

Moreover, term “network side” or “network device side” refers to a side of a network, may be a certain base station, or may include one or more network devices as mentioned above. Term “user side” or “terminal side” or “terminal equipment side” refers to a side of a user or terminal, may be a certain UE, or may include one or more terminal equipments as mentioned above. Unless otherwise specified herein, “device” may refer to a network device, or may refer to a terminal equipment.

Scenarios of embodiments of the present disclosure are described through the following examples, however the present disclosure is not limited thereto.

FIG. 2 is a schematic diagram of a communication system in embodiments of the present disclosure, schematically describing a situation by taking a terminal equipment and a network device as an example, and as shown in FIG. 2, a communication system 100 may include a network device 101 and terminal equipments 102, 103. For simplicity, FIG. 2 only takes two terminal equipments and one network device as an example for description, however embodiments of the present disclosure are not limited thereto.

In embodiments of the present disclosure, transmission of existing or future implementable services may be performed between a network device 101 and terminal equipments 102, 103. For example, these services may include but be not limited to: enhanced Mobile Broadband (eMBB), massive Machine Type Communication (mMTC), Ultra-Reliable and Low-Latency Communication (URLLC) and so on.

It is worth noting that FIG. 2 shows that two terminal equipments 102 and 103 are within a coverage range of a network device 101, but the present disclosure is not limited thereto. Two terminal equipments 102 and 103 may be not within a coverage range of a network device 101, or one terminal equipment 102 is within a coverage range of a network device 101 while the other terminal equipment 103 is outside a coverage range of a network device 101.

A terminal equipment may perform Conditional Handover (CHO), wherein a network device (e.g., a source gNB) may perform CHO configuration for a terminal equipment via RRC, for example configure a CHO candidate cell. For a CHO procedure, related arts may be further referred to.

A terminal equipment may also perform an LTM procedure, wherein a network device (e.g., a gNB) receives L1 measurement reporting from a terminal equipment, and based on the L1 measurement reporting, a network device may change a serving cell of a terminal equipment via a cell switch command signalled via a MAC CE.

For example, after LTM cell switch, a terminal equipment does not change a security key; and supports subsequent LTM. LTM supports intra-gNB-DU mobility and intra-gNB-CU inter-gNB-DU mobility. LTM supports intra-frequency and inter-frequency mobility, including mobility to an inter-frequency cell that is not a current serving cell. LTM may support the following scenarios: PCell change in non-CA scenario and non-DC scenario, PCell change in CA scenario, and, in dual connectivity scenarios, MCG PCell change and SCG PSCell change without MN involvement (i.e., intra-SN PSCell change).

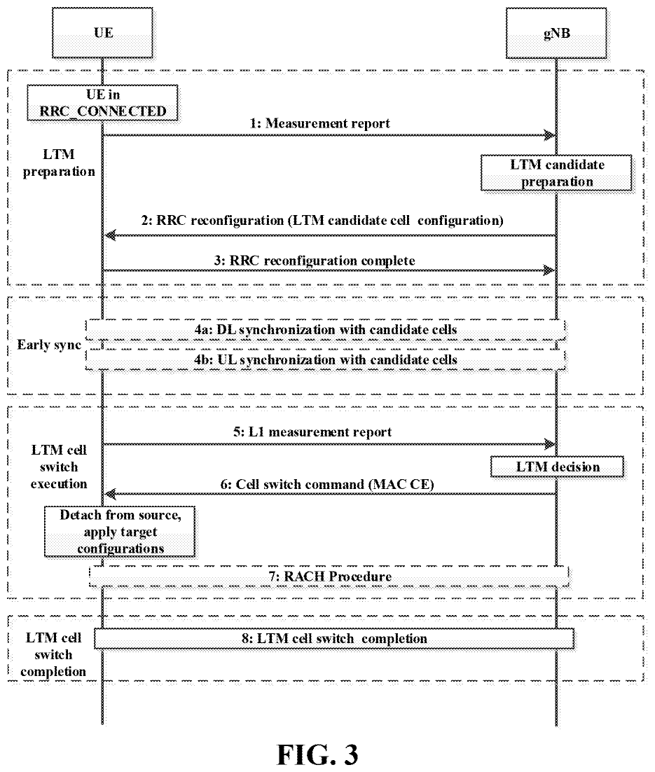

FIG. 3 is a schematic diagram of a signaling procedure of LTM. As shown in FIG. 3, an LTM procedure may include:
Step 1: a UE transmits a MeasurementReport message to a gNB, and the gNB decides to configure LTM and initiates a candidate cell configuration;
Step 2: a gNB transmits an RRCReconfiguration message including LTM candidate cell configuration(s) of one or more candidate cells to a UE;
Step 3: a UE stores LTM candidate cell configuration(s) and transmits an RRCReconfigurationComplete message to a gNB;
Step 4: before receiving a cell switch command, a UE performs DL synchronization with a candidate cell;

When UE-based TA measurement is configured, a UE obtains a TA value of a candidate cell via measurement; otherwise, before receiving a cell switch command, a UE performs early TA acquisition for a candidate cell as a network requested, and may transmit preamble completion to an indicated candidate cell via CFRA triggered by a PDCCH order from a source cell, and subsequent UEs. To minimize data interruption in a source cell caused by CFRA to a candidate cell, a UE does not receive a random access response for obtaining a TA value from a network, and a TA value of the candidate cell is indicated in a cell switch command. A UE does not maintain a TA timer of the candidate cell and relies on a network to ensure TA validity;
Step 5: a UE performs L1 measurement on a configured candidate cell and transmits an L1 measurement report to a gNB. L1 measurement should be performed as long as RRC reconfiguration (Step 2) is applied;
Step 6: a gNB decides to perform a cell switch to a target cell and transmits a MAC CE for discovering cell switch via a candidate configuration index including the target cell. A UE is handed over to a target cell and applies a configuration indicated by the candidate configuration index;
Step 7: if a UE does not have a valid TA of a target cell, the UE performs a random access procedure to the target cell. If an LTM cell switch command MAC CE includes information of CFRA, a UE performs CFRA;
Step 8: a UE completes an LTM cell switch procedure by transmitting an RRCReconfigurationComplete message to a target cell. If a UE has performed a random access procedure in Step 7, the UE considers that LTM cell switch execution is successfully completed when the random access procedure is successfully completed. For RACH-less LTM, a UE considers that LTM cell switch execution is successfully completed when the UE determines that a network has successfully received first UL data of the UE. A UE determines that the first UL data of the UE is successful received by receiving one PDCCH for scheduling a new transmission after the first UL data and addressing a UE's C-RNTI in a target cell. The PDCCH carries DL assignment, or a UL grant for an HARQ process same as first UL data.

Candidate LTM is performed by repeating steps of early synchronization, LTM cell switch execution and LTM cell switch completion, and other LTM candidate cell configurations are not released after completion of LTM cell switch each time. That is, LTM candidate cell configurations provided in Step 2 are used, and Steps 4-8 may be performed multiple times.

The above schematically describes CHO and LTM. The following describes recovery of a handover failure and recovery of a radio link failure.

For recovery of a handover failure, a timer-based Handover Failure (HOF) procedure is supported in NR. An RRC connection reestablishment procedure is used for recovery of a handover failure, except in certain CHO or DAPS handover scenarios:
in case of a DAPS handover failure, if a source link has not been released, a UE falls back to a source cell configuration, restores connection with a source cell, and reports the DAPS handover failure via the source cell, and does not trigger RRC connection reestablishment;
when an initial CHO execution attempt fails or a HO fails, a UE performs cell selection, and if a selected cell is one CHO candidate cell and if a network device configures the UE with attempt CHO after UE handover/CHO failure, the UE attempts CHO execution once, otherwise, performs reestablishment.

For recovery of a radio link failure, after an RLF is declared, a UE will:
maintain RRC_CONNECTED;
in case of DAPS handover, for an RLF in a source cell: stop all data transmissions or receptions via a source link and release the source link, but maintain a source RRC configuration; if a handover failure is subsequently detected in a target cell, the UE: selects one suitable cell and then initiates RRC reestablishment; and enters RRC_IDLE if no suitable cell is found within a certain period of time after a handover failure is declared;
in case of CHO, for an RLF in a source cell: select one suitable cell and if a selected cell is one CHO candidate cell and if a network device configureds the UE with attempt CHO after an RLF, the UE attempts CHO execution once, otherwise, performs reestablishment; and enters RRC_IDLE if no suitable cell is found within a certain period of time after a handover failure is declared;
in case of L1/L2 Triggered Mobility (LTM), for an RLF in a source cell: select one suitable cell and if a selected cell is one LTM candidate cell and if a network device configures the UE with attempt LTM after an RLF, the UE attempts LTM execution once, otherwise, performs reestablishment; and enters RRC_IDLE if no suitable cell is found within a certain period of time after a handover failure is declared;
otherwise, in case of an RLF or DAPS handover in a serving cell, for an RLF in a target cell before a source cell is released: select one suitable cell and then initiate RRC reestablishment; and enter RRC_IDLE if no suitable cell is found within a certain period of time after an RLF is declared.

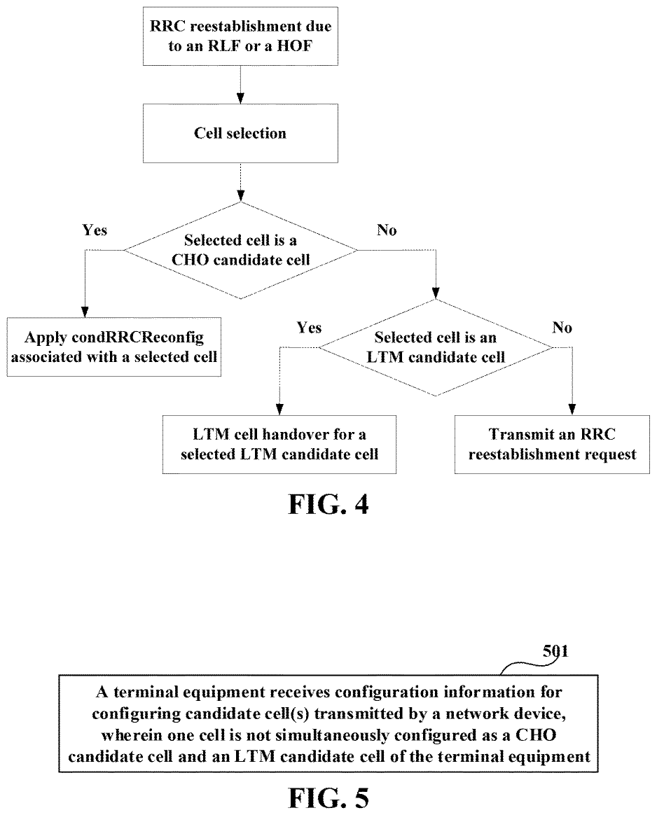

FIG. 4 is a schematic diagram of a failure recovery procedure. As shown in FIG. 4, when a radio link failure or a handover failure occurs, a terminal equipment initiates an RRC connection reestablishment procedure, i.e., performs cell selection first; if a selected cell is a CHO candidate cell, a terminal equipment attempts CHO execution once, otherwise, continues an RRC connection reestablishment procedure, i.e., transmits an RRC reestablishment request message.

Moreover, when a radio link failure or LTM cell switch failure occurs, a terminal equipment initiates an RRC connection reestablishment procedure, i.e., performs cell selection first; if a selected cell is an LTM candidate cell, a terminal equipment attempts LTM execution once, otherwise, continues an RRC connection reestablishment procedure, i.e., transmits an RRC reestablishment request message.

According to the above mechanism, when a radio link failure occurs, if a selected cell is an LTM candidate cell or a CHO candidate cell, a UE attempts LTM execution or CHO execution once. However, when one cell is configured as both a CHO candidate cell and an LTM candidate cell, a terminal equipment is unable to determine to attempt CHO execution once or LTM execution once. In this way, a terminal equipment may be unable to apply fast failure recovery, leading to longer interruption time.

### Embodiments of a First Aspect

Embodiments of the present disclosure provide a method for configuring candidate cell(s). FIG. 5 is a schematic diagram of a method for configuring candidate cell(s) in embodiments of the present disclosure, as shown in FIG. 5, the method includes:
501, a terminal equipment receives configuration information for configuring candidate cell(s) transmitted by a network device, wherein one cell is not simultaneously configured as a Conditional Handover (CHO) candidate cell and an L1/L2 Triggered Mobility (LTM) candidate cell of the terminal equipment.

It is worth noting that the above FIG. 5 only schematically describes embodiments of the present disclosure, however the present disclosure is not limited thereto. For example, an execution sequence of each operation may be adjusted appropriately, moreover some other operations may be increased or certain operations therein may be further removed. Persons skilled in the art may make appropriate modifications according to the above contents, not being limited to records in the above FIG. 5.

In some embodiments, the terminal equipment does not support CHO and LTM simultaneously.

For example, if a terminal equipment (MCG) is configured with CHO or conditional reconfiguration (ConditionalReconfig) of an MCG, the terminal equipment (MCG) is not configured with LTM or LTM-Config or LTM-Candidate.

For another example, if a terminal equipment (MCG) is configured with LTM or LTM-Config or LTM-Candidate, the terminal equipment (MCG) is not configured with CHO or conditional reconfiguration (ConditionalReconfig) of an MCG.

In some embodiments, the terminal equipment supports CHO and LTM simultaneously; a first cell of the terminal equipment is a CHO candidate cell, a second cell thereof is an LTM candidate cell, and the first cell and the second cell are different cells.

In some embodiments, the first cell is not configured as an LTM candidate cell by a network device, and the second cell is not configured as a CHO candidate cell by a network device. For example, the network device is a gNB, or a gNB-CU of a serving cell, or a gNB-CU of a source cell, or a gNB-DU of a candidate cell.

For example, a CU ensures that a first cell is not configured as an LTM candidate cell and a second cell is not configured as a CHO candidate cell.

In some embodiments, if the first cell is further configured as an LTM candidate cell by a network device, or if the second cell is further configured as a CHO candidate cell by a network device, the terminal equipment releases LTM configuration or CHO configuration when performing handover or when a radio link failure is triggered or in case of a handover failure or when an RRC connection reestablishment procedure is initiated.

For example, a terminal equipment releases LTM configuration when at least one of the following events occurs: handover (L3 HO/CHO/LTM) execution (e.g., T304 start/running), radio link failure trigger and/or handover failure (e.g., T304 expires), or initiation of an RRC connection reestablishment procedure (e.g., T311 start/running).

For another example, a terminal equipment releases CHO configuration when at least one of the following events occurs: handover (L3 HO/CHO/LTM) execution, radio link failure trigger and/or handover failure (T304 expires), or initiation of an RRC connection reestablishment procedure.

In some embodiments, the handover failure includes that a timer T304 or a first timer expires, the first timer being different from the timer T304. For example, in case of LTM cell switch execution, the timer T304 is started, or in case of LTM cell switch execution, the first timer is started.

In some embodiments, the timer T304 or the first timer is configured with a first value applicable to random access-based LTM and non-random access LTM; or the timer T304 or the first timer is configured with a second value and a third value, the second value being applicable to random access-based LTM, and the third value being applicable to non-random access LTM.

In some embodiments, the terminal equipment initiates RRC connection reestablishment after a radio link failure; wherein if a cell selected in cell selection is a CHO candidate cell, the terminal equipment attempts to execute CHO; if a cell selected in the cell selection is an LTM candidate cell, the terminal equipment attempts to execute LTM.

The radio link failure includes: an RLF of a source cell when CHO is configured, or an RLF when LTM is configured, or an RLF of a source cell when LTM is configured, or an RLF of a target cell when LTM is configured.

For example, if RRC connection reestablishment is initiated due to a radio link failure, if a cell selected in cell selection is a CHO candidate cell, a UE attempts CHO execution once; and if a cell selected in cell selection is an LTM candidate cell, a UE attempts LTM execution once.

A CHO candidate cell may be a CHO candidate cell of an MCG or a CHO candidate cell of an SCG; or, a CHO candidate cell of an MCG may be a CHO candidate cell of an MCG for which an SCG is not configured, or may be an MCG CHO candidate cell for which an SCG is configured.

In some embodiments, the terminal equipment initiates RRC connection reestablishment after an LTM failure; wherein if a cell selected in cell selection is a CHO candidate cell, the terminal equipment attempts to execute CHO; if a cell selected in the cell selection is an LTM candidate cell, the terminal equipment attempts to execute LTM.

For example, if RRC connection reestablishment is initiated due to an LTM failure, if a cell selected in cell selection is a CHO candidate cell, a UE attempts CHO execution once; (otherwise) if a cell selected in cell selection is an LTM candidate cell, a UE attempts LTM execution once; otherwise, the terminal equipment transmits an RRC reestablishment request.

In some embodiments, the terminal equipment initiates RRC connection reestablishment after an LTM failure; wherein if a cell selected in cell selection is an LTM candidate cell, the terminal equipment attempts to execute LTM; otherwise, the terminal equipment transmits an RRC reestablishment request.

For example, if RRC connection reestablishment is initiated due to an LTM failure, if a cell selected in cell selection is an LTM candidate cell, a UE attempts LTM execution once; otherwise (for example a cell selected in cell selection is a CHO candidate cell), a UE transmits an RRC reestablishment request.

In some embodiments, the terminal equipment initiates RRC connection reestablishment after a handover failure; wherein if a cell selected in cell selection is a CHO candidate cell, the terminal equipment attempts to execute CHO; if a cell selected in the cell selection is an LTM candidate cell, the terminal equipment attempts to execute LTM.

Handover may include at least one of the following: reconfiguration with synchronization; reconfiguration with L3 synchronization; reconfiguration with L3 synchronization of an MCG, triggered by a network; reconfiguration with conditional synchronization of an MCG; reconfiguration with conditional synchronization of an MCG including reconfiguration with conditional synchronization of an SCG; or L1/L2 Triggered Mobility (LTM) of an MCG.

For example, if RRC connection reestablishment is initiated due to a failure of reconfiguration with sync, if a cell selected in cell selection is a CHO candidate cell, a UE attempts CHO execution once; (otherwise) if a cell selected in cell selection is an LTM candidate cell, a UE attempts LTM execution once; otherwise, the terminal equipment transmits an RRC reestablishment request.

In some embodiments, the terminal equipment initiates RRC connection reestablishment after a handover failure, wherein if a cell selected in cell selection is a CHO candidate cell, the terminal equipment attempts to execute CHO; otherwise, the terminal equipment transmits an RRC reestablishment request.

For example, if RRC connection reestablishment is initiated due to a failure of reconfiguration with sync, if a cell selected in cell selection is a CHO candidate cell, a UE attempts CHO execution once; otherwise (if a cell selected in cell selection is an LTM candidate cell), a UE transmits an RRC reestablishment request.

The above schematically describes embodiments of the present disclosure, the present disclosure is not limited thereto, and further description is provided through the following examples.

Table 1-1 and Table 1-2 exemplarily show one example, but the present disclosure is not limited thereto.

TABLE 1-1

For a UE, CHO cannot be configured simultaneously with LTM.

Or,

TABLE 1-2

For a UE, LTM cannot be configured simultaneously with CHO.

In the above example, “cannot” may be replaced with “shall not”, “will not”, or the like.

As shown in Table 1, if a UE does not configure LTM/CHO simultaneously, one cell is not configured simultaneously as a CHO candidate cell and an LTM candidate cell for the UE.

Table 2 exemplarily shows another example, but the present disclosure is not limited thereto.

TABLE 2
5.3.7.3 Actions following cell selection while T311 is running
Upon selecting a suitable NR cell, the UE shall:

| 1> | ensure having valid and up to date essential system information as specified in clause | |
|---|---|---|
| | 5.2.2.2; | |
| 1> | stop timer T311; | |
| 1> | if T390 is running: | |
| | 2> | stop timer T390 for all access categories; |
| | 2> | perform the actions as specified in 5.3.14.4; |
| 1> | stop the relay (re)selection procedure, if ongoing; | |
| 1> | if the cell selection is triggered by detecting radio link failure of the MCG or re- | |
| | configuration with sync failure of the MCG or mobility from NR failure, and | |
| 1> | if attemptCondReconfig is configured; and | |
| 1> | if the selected cell is not configured with CondEventT1, or the selected cell is | |
| | configured with CondEventT1 and leaving condition has not been fulfilled; and | |
| 1> | if the selected cell is one of the candidate cells for which the reconfigurationWithSync | |
| | is included in the masterCellGroup in the MCG VarConditionalReconfig: | |
| | 2> | if the UE supports RLF-Report for conditional handover, set the choCellId in the |
| | | VarRLF-Report to the global cell identity, if available, otherwise to the physical cell |
| | | identity and carrier frequency of the selected cell; |
| | 2> | apply the stored condRRCReconfig associated to the selected cell and perform |
| | | actions as specified in 5.3.5.3; |

NOTE 1: It is left to network implementation to how to avoid keystream reuse in case of

CHO based recovery after a failed handover without key change.

| 1> | else, if the cell selection is triggered by detecting radio link failure of the MCG or re- | |
|---|---|---|
| | configuration with sync failure of the MCG or mobility from NR failure; and | |
| 1> | if attemptLTM-Switch is configured; and | |
| 1> | if the selected cell is one of the LTM candidate cells in the LTM-Candidate IE within | |
| | VarLTM-Config associated with the MCG: | |
| | 2> | perform the LTM cell switch procedure for the selected LTM candidate cell |
| | | according to the actions specified in 5.3.5.x.6. |

Editor's Note: FFS about the co-existance of LTM and CHO.

| 1> | else: | |
|---|---|---|
| | 2> | if UE is configured with attemptCondReconfig; or |
| | 2> | if UE is configured with attemptLTM-Switch: |

| | |
|---|---|
| 3> | reset MAC; |

...

Table 3 exemplarily shows another example, but the present disclosure is not limited thereto.

```
TABLE 3
- RRCReconfiguration
The RRCReconfiguration message is the command to modify an RRC connection. It may
convey information for measurement configuration, mobility control, radio resource
configuration (including RBs, MAC main configuration and physical channel
configuration) and AS security configuration.
  Signalling radio bearer: SRB1 or SRB3
  RLC-SAP: AM
  Logical channel: DCCH
  Direction: Network to UE
```

RRCReconfiguration message

-- ASN1START
-- TAG-RRCRECONFIGURATION-START

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration-IEs, |
| criticalExtensionsFuture | SEQUENCE { } |

}
}

| | |
|---|---|
| RRCReconfiguration-IEs ::= | SEQUENCE { |
| radioBearerConfig | RadioBearerConfig |

OPTIONAL, -- Need M

| | |
|---|---|
| secondaryCellGroup | OCTET STRING (CONTAINING |
| CellGroupConfig) | OPTIONAL, -- Cond SCG |
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration-v1530-IEs |

OPTIONAL
}

| | |
|---|---|
| RRCReconfiguration-v1530-IEs ::= | SEQUENCE { |
| masterCellGroup | OCTET STRING (CONTAINING |
| CellGroupConfig) | OPTIONAL, -- Need M |
| fullConfig | ENUMERATED {true} |

OPTIONAL, -- Cond FullConfig

| | |
|---|---|
| dedicatedNAS-MessageList | SEQUENCE (SIZE(1..maxDRB)) OF |
| DedicatedNAS-Message | OPTIONAL, -- Cond nonHO |
| masterKeyUpdate | MasterKeyUpdate |

OPTIONAL, -- Cond MasterKeyChange

| | |
|---|---|
| dedicatedSIB1-Delivery | OCTET STRING (CONTAINING SIB1) |

OPTIONAL, -- Need N

| | |
|---|---|
| dedicatedSystemInformationDelivery | OCTET STRING (CONTAINING |
| SystemInformation) | OPTIONAL, -- Need N |
| otherConfig | OtherConfig |

OPTIONAL, -- Need M

| | |
|---|---|
| nonCriticalExtension | RRCReconfiguration-v1540-IEs |

OPTIONAL
}

| | |
|---|---|
| RRCReconfiguration-v1540-IEs ::= | SEQUENCE { |
| otherConfig-v1540 | OtherConfig-v1540 |

OPTIONAL, -- Need M

| | |
|---|---|
| nonCriticalExtension | RRCReconfiguration-v1560-IEs |

OPTIONAL
}

| | |
|---|---|
| RRCReconfiguration-v1560-IEs ::= | SEQUENCE { |
| mrdc-SecondaryCellGroupConfig | SetupRelease { MRDC- |
| SecondaryCellGroupConfig } | OPTIONAL, -- Need M |
| radioBearerConfig2 | OCTET STRING (CONTAINING |
| RadioBearerConfig) | OPTIONAL, -- Need M |
| sk-Counter | SK-Counter |

OPTIONAL, -- Need N

| | |
|---|---|
| nonCriticalExtension | RRCReconfiguration-v1610-IEs |

OPTIONAL
}

| | |
|---|---|
| RRCReconfiguration-v1610-IES := | SEQUENCE { |
| otherConfig-v1610 | OtherConfig-v1610 |

OPTIONAL, -- Need M

| | |
|---|---|
| bap-Config-r16 | SetupRelease { BAP-Config-r16 } |

OPTIONAL, -- Need M

| | |
|---|---|
| iab-IP-AddressConfigurationList-r16 | IAB-IP-AddressConfigurationList-r16 |

OPTIONAL, -- Need M

| | |
|---|---|
| conditionalReconfiguration-r16 | ConditionalReconfiguration-r16 |

OPTIONAL, -- Need M

| | |
|---|---|
| daps-SourceRelease-r16 | ENUMERATED{true} |

OPTIONAL, -- Need N

| | |
|---|---|
| t316-r16 | SetupRelease {T316-r16} |

OPTIONAL, -- Need M

| | |
|---|---|
| needForGapsConfigNR-r16 | SetupRelease {NeedForGapsConfigNR- |
| r16} | OPTIONAL, -- Need M |
| onDemandSIB-Request-r16 | SetupRelease { OnDemandSIB-Request- |
| r16 } | OPTIONAL, -- Need M |
| dedicatedPosSysInfoDelivery-r16 | OCTET STRING (CONTAINING |
| PosSystemInformation-r16-Ies) | OPTIONAL, -- Need N |
| sl-ConfigDedicatedNR-r16 | SetupRelease {SL-ConfigDedicatedNR-r16} |

OPTIONAL, -- Need M

| | |
|---|---|
| sl-ConfigDedicatedEUTRA-Info-r16 | SetupRelease {SL- |
| ConfigDedicatedEUTRA-Info-r16} | OPTIONAL, -- Need M |
| targetCellSMTC-SCG-r16 | SSB-MTC |

OPTIONAL, -- Need S

| | |
|---|---|
| nonCriticalExtension | RRCReconfiguration-v1700-IEs |

OPTIONAL
}

| | |
|---|---|
| RRCReconfiguration-v1700-IEs ::= | SEQUENCE { |
| otherConfig-v1700 | OtherConfig-v1700 |

OPTIONAL, -- Need M

| | |
|---|---|
| sl-L2RelayUE-Config-r17 | SetupRelease { SL-L2RelayUE-Config-r17 |
| } | OPTIONAL, -- Need M |
| sl-L2RemoteUE-Config-r17 | SetupRelease { SL-L2RemoteUE-Config- |
| r17 } | OPTIONAL, -- Need M |
| dedicatedPagingDelivery-r17 | OCTET STRING (CONTAINING Paging) |

OPTIONAL, -- Cond PagingRelay

| | |
|---|---|
| needForGapNCSG-ConfigNR-r17 | SetupRelease {NeedForGapNCSG- |
| ConfigNR-r17} | OPTIONAL, -- Need M |
| needForGapNCSG-ConfigEUTRA-r17 | SetupRelease {NeedForGapNCSG- |
| ConfigEUTRA-r17} | OPTIONAL, -- Need M |
| musim-GapConfig-r17 | SetupRelease {MUSIM-GapConfig-r17} |

OPTIONAL, -- Need M

| | |
|---|---|
| ul-GapFR2-Config-r17 | SetupRelease { UL-GapFR2-Config-r17 } |

OPTIONAL, -- Need M

| | |
|---|---|
| scg-State-r17 | ENUMERATED { deactivated } |

OPTIONAL, -- Need N

| | |
|---|---|
| appLayerMeasConfig-r17 | AppLayerMeasConfig-r17 |

OPTIONAL, -- Need M

| | |
|---|---|
| ue-TxTEG-RequestUL-TDOA-Config-r17 | SetupRelease {UE-TxTEG- |
| RequestUL-TDOA-Config-r17} | OPTIONAL, -- Need M |
| nonCriticalExtension | RRCReconfiguration-v18xy-IEs |

OPTIONAL
}

| | |
|---|---|
| RRCReconfiguration-v18xy-IEs ::= | SEQUENCE { |
| ltm-Config-r18 | SetupRelease {LTM-Config-r18} |

OPTIONAL, -- Need M

| | |
|---|---|
| nonCriticalExtension | SEQUENCE { } |

OPTIONAL
}

| | |
|---|---|
| MRDC-SecondaryCellGroupConfig ::= | SEQUENCE { |
| mrdc-ReleaseAndAdd | ENUMERATED {true} |

OPTIONAL, -- Need N

| | |
|---|---|
| mrdc-SecondaryCellGroup | CHOICE { |
| nr-SCG | OCTET STRING (CONTAINING |

RRCReconfiguration),

| | |
|---|---|
| eutra-SCG | OCTET STRING |

}
}

| | |
|---|---|
| BAP-Config-r16 ::= | SEQUENCE { |
| bap-Address-r16 | BIT STRING (SIZE (10)) |

OPTIONAL, -- Need M

| | |
|---|---|
| defaultUL-BAP-RoutingID-r16 | BAP-RoutingID-r16 |

OPTIONAL, -- Need M

| | |
|---|---|
| defaultUL-BH-RLC-Channel-r16 | BH-RLC-ChannelID-r16 |

OPTIONAL, -- Need M

| | |
|---|---|
| flowControlFeedbackType-r16 | ENUMERATED {perBH-RLC-Channel, |
| perRoutingID, both} | OPTIONAL, -- Need R |

...
}

| | |
|---|---|
| MasterKeyUpdate ::= | SEQUENCE { |
| keySetChangeIndicator | BOOLEAN, |
| nextHopChainingCount | NextHopChainingCount, |
| nas-Container | OCTET STRING |

OPTIONAL, -- Cond securityNASC
...
}

| | |
|---|---|
| OnDemandSIB-Request-r16 ::= | SEQUENCE { |
| onDemandSIB-RequestProhibitTimer-r16 | ENUMERATED {s0, sodot5, s1, s2, |

s5, s10, s20, s30}
}

| | |
|---|---|
| T316-r16 ::= | ENUMERATED {ms50, ms100, ms200, ms300, ms400, ms500, |

ms600, ms1000, ms1500, ms2000}

| | |
|---|---|
| IAB-IP-AddressConfigurationList-r16 ::= | SEQUENCE { |
| iab-IP-AddressToAddModList-r16 | SEQUENCE (SIZE(1..maxIAB-IP-Address- |

r16)) OF IAB-IP-AddressConfiguration-r16 OPTIONAL, -- Need N

| | |
|---|---|
| iab-IP-AddressToReleaseList-r16 | SEQUENCE (SIZE(1..maxIAB-IP-Address- |
| r16)) OF IAB-IP-AddressIndex-r16 | OPTIONAL, -- Need N |

...
}

| | |
|---|---|
| IAB-IP-AddressConfiguration-r16 ::= | SEQUENCE { |
| iab-IP-AddressIndex-r16 | IAB-IP-AddressIndex-r16, |
| iab-IP-Address-r16 | IAB-IP-Address-r16 |

OPTIONAL, -- Need M

| | |
|---|---|
| iab-IP-Usage-r16 | IAB-IP-Usage-r16 |

OPTIONAL, -- Need M

| | |
|---|---|
| iab-donor-DU-BAP-Address-r16 | BIT STRING (SIZE(10)) |

OPTIONAL, -- Need M
...
}

| | |
|---|---|
| SL-ConfigDedicatedEUTRA-Info-r16 ::= | SEQUENCE { |
| sl-ConfigDedicatedEUTRA-r16 | OCTET STRING |

OPTIONAL, -- Need M

| | |
|---|---|
| sl-TimeOffsetEUTRA-List-r16 | SEQUENCE (SIZE (8)) OF SL- |
| TimeOffsetEUTRA-r16 | OPTIONAL -- Need M |

}

| | |
|---|---|
| SL-TimeOffsetEUTRA-r16 ::= | ENUMERATED {ms0, ms0dot25, ms0dot5, |

ms0dot625, ms0dot75, ms1, ms1dot25, ms1dot5, ms1dot75,

ms2, ms2dot5, ms3, ms4, ms5, ms6, ms8,

ms10, ms20}

| | |
|---|---|
| UE-TxTEG-RequestUL-TDOA-Config-r17 ::= | CHOICE { |
| oneShot-r17 | NULL, |
| periodicReporting-r17 | ENUMERATED { ms160, ms320, ms1280, |

ms2560, ms61440, ms81920, ms368640, ms737280 }
}
-- TAG-RRCRECONFIGURATION-STOP
-- ASN1STOP

ltm-Config
This field includes the configuration related to LTM. This field is absent if
conditionalReconfiguration (for MCG) is present.

Each of the above embodiments only exemplarily describes the present disclosure, but the present disclosure is not limited thereto, appropriate modifications may be further made based on each of the above embodiments. For example, each of the above embodiments may be used individually, or one or more of the above embodiments may be combined.

As may be known from the above embodiments, through embodiments of the present disclosure, one cell is not simultaneously configured as a CHO candidate cell and an LTM candidate cell, so that a cell selected in cell selection in fast recovery is unable to be both a CHO candidate cell and an LTM candidate cell, and a terminal equipment is able to perform fast failure recovery, thereby reducing service interruption time and improving user experience.

### Embodiments of a Second Aspect

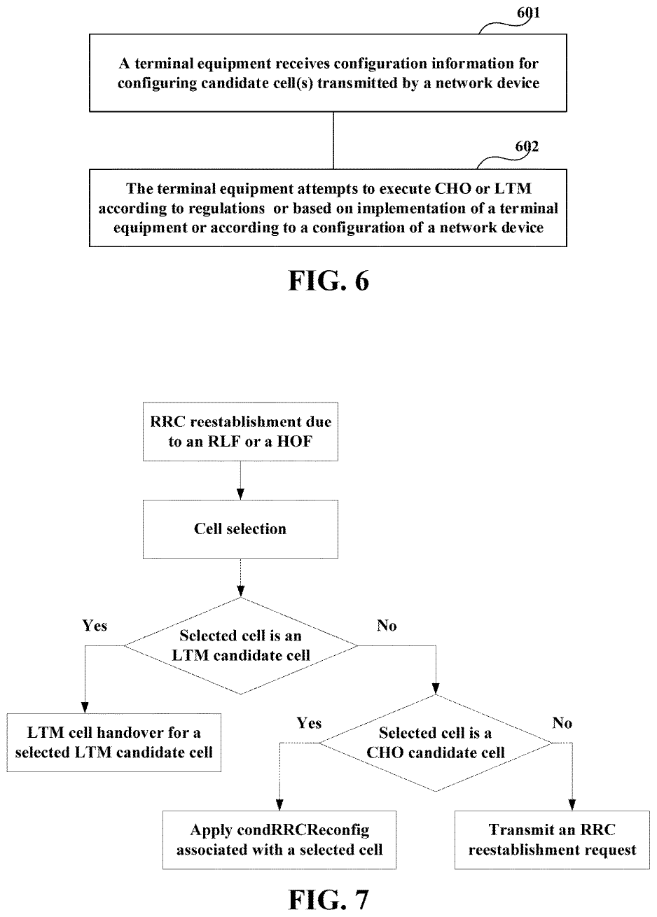

Embodiments of the present disclosure provide a method for applying candidate cell(s). FIG. 6 is a schematic diagram of a method for applying candidate cell(s) in embodiments of the present disclosure, as shown in FIG. 6, the method includes:
601, a terminal equipment receives configuration information for configuring candidate cell(s) transmitted by a network device; and
602, the terminal equipment attempts to execute CHO or LTM according to regulations or based on implementation of a terminal equipment or according to a configuration of a network device.

It is worth noting that the above FIG. 6 only schematically describes embodiments of the present disclosure, however the present disclosure is not limited thereto. For example, an execution sequence of each operation may be adjusted appropriately, moreover some other operations may be increased or certain operations therein may be further removed. Persons skilled in the art may make appropriate modifications according to the above contents, not being limited to records in the above FIG. 6.

In some embodiments, the terminal equipment initiates RRC connection reestablishment after a radio link failure or a handover failure; the terminal equipment performs cell selection; according to a selected cell, the terminal equipment attempts to execute CHO or LTM according to regulations or based on implementation of a terminal equipment or according to a configuration of a network device.

In some embodiments, the radio link failure includes: an RLF of a source cell when CHO is configured, or an RLF when LTM is configured, or an RLF of a source cell when LTM is configured, or an RLF of a target cell when LTM is configured.

In some embodiments, the handover includes at least one of the following: reconfiguration with synchronization; reconfiguration with L3 synchronization; reconfiguration with L3 synchronization of an MCG, triggered by a network; reconfiguration with conditional synchronization of an MCG; reconfiguration with conditional synchronization of an MCG including reconfiguration with conditional synchronization of an SCG; or L1/L2 Triggered Mobility (LTM) of an MCG.

In some embodiments, the terminal equipment attempts to execute CHO or LTM according to regulations.

For example, if a cell selected in cell selection is an LTM candidate cell, the terminal equipment attempts to execute LTM; otherwise, if a cell selected in cell selection is a CHO candidate cell, the terminal equipment attempts to execute CHO; otherwise, the terminal equipment transmits an RRC reestablishment request.

FIG. 7 is a schematic diagram of failure recovery in embodiments of the present disclosure. As shown in FIG. 7, when a radio link failure or a handover failure occurs, a terminal equipment initiates an RRC connection reestablishment procedure, i.e., performs cell selection first; if a selected cell is an LTM candidate cell, a terminal equipment attempts LTM execution once; otherwise, if a selected cell is a CHO candidate cell, a terminal equipment attempts CHO execution once, otherwise, a terminal equipment continues an RRC connection reestablishment procedure, i.e., transmits an RRC reestablishment request message.

Table 4 exemplarily shows another example, but the present disclosure is not limited thereto.

TABLE 4
After RLF is declared, the UE:

| - | stays in RRC_CONNECTED; | |
|---|---|---|
| - | in case of DAPS handover, for RLF in the source cell: | |
| | - | stops any data transmission or reception via the source link and releases the source |
| | | link, but maintains the source RRC configuration; |
| | - | if handover failure is then declared at the target cell, the UE: |

| | |
|---|---|
| - | selects a suitable cell and then initiates RRC re-establishment; |
| - | enters RRC_IDLE if a suitable cell was not found within a certain time after |
| | handover failure was declared. |

| - | in case of LTM, for RLF (in the source cell or in the target cell): | |
|---|---|---|
| | - | selects a suitable cell and if the selected cell is an LTM candidate cell and if |
| | | network configured the UE to try LTM after RLF then the UE attempts LTM |
| | | execution once, otherwise re-establishment is performed; |
| | - | enters RRC_IDLE if a suitable cell was not found within a certain time after |
| | | RLF was declared. |
| - | in case of CHO, for RLF in the source cell: | |
| | - | selects a suitable cell and if the selected cell is a CHO candidate and if network |
| | | configured the UE to try CHO after RLF then the UE attempts CHO execution once, |
| | | otherwise re-establishment is performed; |
| | - | enters RRC_IDLE if a suitable cell was not found within a certain time after RLF |
| | | was declared. |
| - | otherwise, for RLF in the serving cell or in case of DAPS handover, for RLF in the | |
| | target cell before releasing the source cell: | |
| | - | selects a suitable cell and then initiates RRC re-establishment; |
| | - | enters RRC_IDLE if a suitable cell was not found within a certain time after RLF |
| | | was declared. |

Table 5 exemplarily shows another example, but the present disclosure is not limited thereto.

TABLE 5
After RLF is declared, the UE:

| - | stays in RRC_CONNECTED; | |
|---|---|---|
| - | in case of DAPS handover, for RLF in the source cell: | |
| | - | stops any data transmission or reception via the source link and releases the source |
| | | link, but maintains the source RRC configuration; |
| | - | if handover failure is then declared at the target cell, the UE: |

| | |
|---|---|
| - | selects a suitable cell and then initiates RRC re-establishment; |
| - | enters RRC_IDLE if a suitable cell was not found within a certain time after |
| | handover failure was declared. |

| - | in case of CHO or LTM, for RLF in the source cell: | |
|---|---|---|
| | - | selects a suitable cell and if the selected cell is an LTM candidate cell and if |
| | | network configured the UE to try LTM after RLF then the UE attempts LTM |
| | | execution once; otherwise, if the selected cell is a CHO candidate and if network |
| | | configured the UE to try CHO after RLF then the UE attempts CHO execution |
| | | once, otherwise re-establishment is performed; |
| | - | enters RRC_IDLE if a suitable cell was not found within a certain time after RLF |
| | | was declared. |
| - | otherwise, for RLF in the serving cell or in case of DAPS handover, for RLF in the | |
| | target cell before releasing the source cell: | |
| | - | selects a suitable cell and then initiates RRC re-establishment; |

- enters RRC_IDLE if a suitable cell was not found within a certain time after RLF was
declared.

Table 6 exemplarily shows another example, but the present disclosure is not limited thereto.

TABLE 6
5.3.7.3 Actions following cell selection while T311 is running
Upon selecting a suitable NR cell, the UE shall:

| 1> | ensure having valid and up to date essential system information as specified in clause | |
|---|---|---|
| | 5.2.2.2; | |
| 1> | stop timer T311; | |
| 1> | if T390 is running: | |
| | 2> | stop timer T390 for all access categories; |
| | 2> | perform the actions as specified in 5.3.14.4; |
| 1> | stop the relay (re)selection procedure, if ongoing; | |
| 1> | if the cell selection is triggered by detecting radio link failure of the MCG (or re- | |
| | configuration with sync failure of the MCG or mobility from NR failure); and | |
| 1> | if attemptLTM-Switch is configured; and | |
| 1> | if the selected cell is one of the LTM candidate cells in the LTM-Candidate IE | |
| | within VarLTM-Config associated with the MCG: | |
| | 2> | perform the LTM cell switch procedure for the selected LTM candidate cell |
| | | according to the actions specified in 5.3.5.x.6. |
| 1> | if the cell selection is triggered by detecting radio link failure of the MCG or re- | |
| | configuration with sync failure of the MCG or mobility from NR failure, and | |
| 1> | if attemptCondReconfig is configured; and | |
| 1> | if the selected cell is not configured with CondEventT1, or the selected cell is | |
| | configured with CondEventT1 and leaving condition has not been fulfilled; and | |
| 1> | if the selected cell is one of the candidate cells for which the reconfigurationWithSync | |
| | is included in the masterCellGroup in the MCG VarConditionalReconfig: | |
| | 2> | if the UE supports RLF-Report for conditional handover, set the choCellId in the |
| | | VarRLF-Report to the global cell identity, if available, otherwise to the physical cell |
| | | identity and carrier frequency of the selected cell; |
| | 2> | apply the stored condRRCReconfig associated to the selected cell and perform |
| | | actions as specified in 5.3.5.3; |

NOTE 1: It is left to network implementation to how to avoid keystream reuse in case of

CHO based recovery after a failed handover without key change.

Editor's Note: FFS about the co-existance of LTM and CHO.

| 1> | else: | |
|---|---|---|
| | 2> | if UE is configured with attemptCondReconfig; or |
| | 2> | if UE is configured with attemptLTM-Switch: |

| | |
|---|---|
| 3> | reset MAC; |

...

Thus, when a cell is both an LTM candidate and a CHO candidate, LTM execution is attempted first, a terminal equipment is able to perform fast failure recovery, thereby reducing service interruption time and improving user experience. Furthermore, on one hand, there is no restriction on network configuration, allowing for more network flexibility. On the other hand, a terminal behavior is specified, which reduces the number of tests for a terminal equipment, thereby lowering the cost of a terminal equipment.

In some embodiments, CHO execution or LTM execution is attempted based on implementation of a terminal equipment.

For example, if a cell selected in cell selection is an LTM candidate cell, the terminal equipment attempts to execute LTM; otherwise, the terminal equipment transmits an RRC reestablishment request. Or, if a cell selected in cell selection is a CHO candidate cell, the terminal equipment attempts to execute CHO; otherwise, the terminal equipment transmits an RRC reestablishment request. Or, if a cell selected in cell selection is both a CHO candidate cell and an LTM candidate cell, the terminal equipment attempts to execute CHO or LTM.

For another example, if LTM execution does not include RLC reestablishment and/or PDCP data recovery, the terminal equipment attempts to execute LTM; and/or, if an LTM configuration includes a Contention-Free Random Access (CFRA) configuration, the terminal equipment attempts to execute LTM.

For another example, if LTM execution includes RLC reestablishment and/or PDCP data recovery, the terminal equipment attempts to execute CHO; and/or, if an LTM configuration does not include a Contention-Free Random Access (CFRA) configuration, the terminal equipment attempts to execute CHO.

In some embodiments, CHO execution or LTM execution is attempted according to a configuration of a network device.

For example, in the following situations, a terminal equipment attempts to execute CHO according to a configuration of a network device: CHO is configured by a network device first; and/or, a network device configures attemptCondReconfig but does not configure attemptLTM-Switch; and/or, an LTM configuration is released by a network device.

For another example, in the following situations, a terminal equipment attempts to execute LTM according to a configuration of a network device: LTM is configured by a network device first; and/or, a network device configures attemptLTM-Switch but does not configure attemptCondReconfig; and/or, a CHO configuration is released by a network device.

Table 7 exemplarily shows another example, but the present disclosure is not limited thereto.

TABLE 7
- ConditionalReconfiguration
The IE ConditionalReconfiguration is used to add, modify and release the configuration of
conditional reconfiguration.

ConditionalReconfiguration information element
-- ASN1START
-- TAG-CONDITIONALRECONFIGURATION-START

| | |
|---|---|
| ConditionalReconfiguration-r16 ::= | SEQUENCE { |
| attemptCondReconfig-r16 | ENUMERATED {true} |

OPTIONAL, -- Cond CHO

| | |
|---|---|
| condReconfigToRemoveList-r16 | CondReconfigToRemoveList-r16 |

OPTIONAL, -- Need N

| | |
|---|---|
| condReconfigToAddModList-r16 | CondReconfigToAddModList-r16 |

OPTIONAL, -- Need N
...

| | |
|---|---|
| CHOattempt-Prioritization-r18 | ENUMERATED {enabled} |

OPTIONAL, -- Cond attempCHO(or needN)
}

| | |
|---|---|
| CondReconfigToRemoveList-r16 ::= | SEQUENCE (SIZE (1.. maxNrofCondCells- |

r16)) OF CondReconfigId-r16
-- TAG-CONDITIONALRECONFIGURATION-STOP
-- ASN1STOP

CHOattempt-Prioritization
(Used to enable CHO execution after RLF or HOF.) If this field is present, CHO
execution is prioritized compared to LTM execution.

| Conditional Presence | Explanation |
|---|---|
| attempCHO | This field is optionally present, Need N, if |
| | attemptCondReconfig is included. Otherwise, the field is |
| | absent. |

As shown in FIG. 7, a network may configure CHO first, and a terminal equipment attempts to execute CHO based on a network configuration.

Table 8 exemplarily shows another example, but the present disclosure is not limited thereto.

TABLE 8

- LTM-Config
The IE LTM-Config is used to provide LTM candidate configurations.

LTM-Config information element

-- ASN1START
-- TAG-LTM-CONFIG-START

| | |
|---|---|
| LTM-Config-r18 ::= | SEQUENCE { |
| ltm-ReferenceConfiguration-r18 | OCTET STRING (CONTAINING |
| RRCReconfiguration) | OPTIONAL, -- Need M |
| ltm-CandidateToReleaseList-r18 | LTM-CandidateToReleaseList-r18 |

OPTIONAL, -- Need N

| | |
|---|---|
| ltm-CandidateToAddModList-r18 | LTM-CandidateToAddModList-r18 |

OPTIONAL, -- Need N

| | |
|---|---|
| ltm-ServingCellNoResetID-r18 | INTEGER (1.. maxNrofCellsLTM-r18- |
| plus-1) | OPTIONAL, -- Cond FirstLTM-Only |
| ltm-CSI-ResourceConfigToAddModList-r18 | SEQUENCE (SIZE |

(1..maxNrofLTM-CSI-ResourceConfigurations-r18)) OF LTM-CSI-ResourceConfig-r18
OPTIONAL, -- Need N

| | |
|---|---|
| ltm-CSI-ResourceConfigToReleaseList-r18 | SEQUENCE (SIZE |

(1..maxNrofLTM-CSI-ResourceConfigurations-r18)) OF LTM-CSI-ResourceConfigId-r18
OPTIONAL, -- Need N

| | |
|---|---|
| attemptLTM-Switch-r18 | ENUMERATED {true} |

OPTIONAL, -- Cond LTM-MCG

| | |
|---|---|
| LTMattempt-Prioritization-r18 | ENUMERATED {enabled} |

OPTIONAL, -- Cond attempCHO(or need N)

| | |
|---|---|
| ltm-ServingCellUE-MeasuredTA-ID-r18 | INTEGER (1.. maxNrofCaellsLTM- |
| r18-plus-1) | OPTIONAL, -- Cond LTM |

...
}
LTM-CandidateToReleaseList-r18 ::= SEQUENCE (SIZE (1..maxNrofCellsLTM-r18)) OF
LTM-CandidateId-r18
-- TAG-LTM-CONFIG-STOP
-- ASN1STOP

LTMattempt-Prioritization
(Used to enable LTM execution after RLF or HOF.) If this field is present, LTM
execution is prioritized compared to CHO execution.

| Conditional Presence | Explanation |
|---|---|
| attempLTM | This field is optionally present, Need N, if attemptLTM-Switch |
| | is included. Otherwise, the field is absent. |

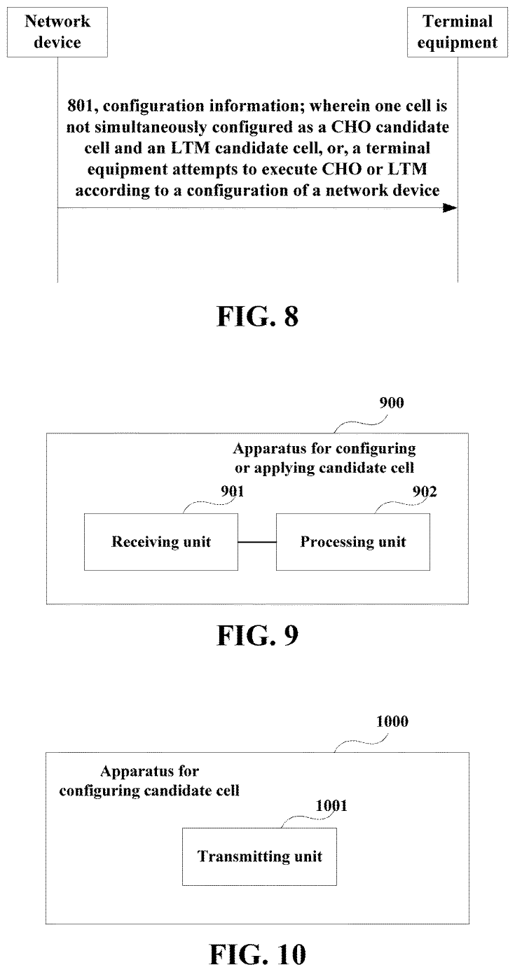

As shown in FIG. 8, a network may configure LTM first, and a terminal equipment attempts to execute LTM based on a network configuration.

Table 9 exemplarily shows another example, but the present disclosure is not limited thereto.

TABLE 9
LTM-Config field descriptions

attemptLTM-Switch
If present, the UE shall execute an LTM cell switch if selected cell is a LTM candidate cell
and it is the first cell selection after failure as described in clause 5.3.7.3 or clause 5.3.10.3.
This field is not included if attemptCondReconfig is present.

As shown in FIG. 9, a network may configure CHO attempting first after a failure, and a terminal equipment attempts to execute CHO based on a network configuration.

Table 10 exemplarily shows another example, but the present disclosure is not limited thereto.

TABLE 10
ConditionalReconfiguration field descriptions

attemptCondReconfig
If present, the UE shall perform conditional reconfiguration if selected cell is a target
candidate cell and it is the first cell selection after failure as described in clause 5.3.7.3. This
field is not included if attemptLTM-Switch is present.

As shown in FIG. 10, a network may configure LTM attempting first after a failure, and a terminal equipment attempts to execute LTM based on a network configuration.

Table 11 exemplarily shows another example, but the present disclosure is not limited thereto. For example, “upon CHO execution is performed” may be replaced with “an RLF is triggered”, “T304 expires”, “RRC reestablishment is initiated”, etc.

TABLE 11

- LTM-Config
The IE LTM-Config is used to provide LTM candidate configurations.

LTM-Config information element

-- ASN1START
-- TAG-LTM-CONFIG-START

| | |
|---|---|
| LTM-Config-r18 ::= | SEQUENCE { |
| ltm-ReferenceConfiguration-r18 | OCTET STRING (CONTAINING |
| RRCReconfiguration) | OPTIONAL, -- Need M |
| ltm-CandidateToReleaseList-r18 | LTM-CandidateToReleaseList-r18 |

OPTIONAL, -- Need N

| | |
|---|---|
| ltm-CandidateToAddModList-r18 | LTM-CandidateToAddModList-r18 |

OPTIONAL, -- Need N

| | |
|---|---|
| ltm-ServingCellNoResetID-r18 | INTEGER (1.. maxNrofCellsLTM-r18-plus- |
| 1) | OPTIONAL, -- Cond FirstLTM-Only |
| ltm-CSI-ResourceConfigToAddModList-r18 | SEQUENCE (SIZE |

(1..maxNrofLTM-CSI-ResourceConfigurations-r18)) OF LTM-CSI-ResourceConfig-r18
OPTIONAL, -- Need N

| | |
|---|---|
| ltm-CSI-ResourceConfigToReleaseList-r18 | SEQUENCE (SIZE |

(1..maxNrofLTM-CSI-ResourceConfigurations-r18)) OF LTM-CSI-ResourceConfigId-r18
OPTIONAL, -- Need N

| | |
|---|---|
| attemptLTM-Switch-r18 | ENUMERATED {true} |

OPTIONAL, -- Cond LTM-MCG

| | |
|---|---|
| releaseForattemptCHO ENUMERATED {true} | OPTIONAL, -- Cond |

attempLTM

| | |
|---|---|
| ltm-ServingCellUE-MeasuredTA-ID-r18 | INTEGER (1.. |
| maxNrofCellsLTM-r18-plus-1) | OPTIONAL, -- Cond LTM |

...
}
LTM-CandidateToReleaseList-r18 ::= SEQUENCE (SIZE (1..maxNrofCellsLTM-r18)) OF
LTM-CandidateId-r18
-- TAG-LTM-CONFIG-STOP
-- ASN1STOP

releaseForattemptCHO
(Used to enable CHO execution after RLF or HOF.) If this field is present, LTM-config
is released by the UE upon CHO execution is performed.

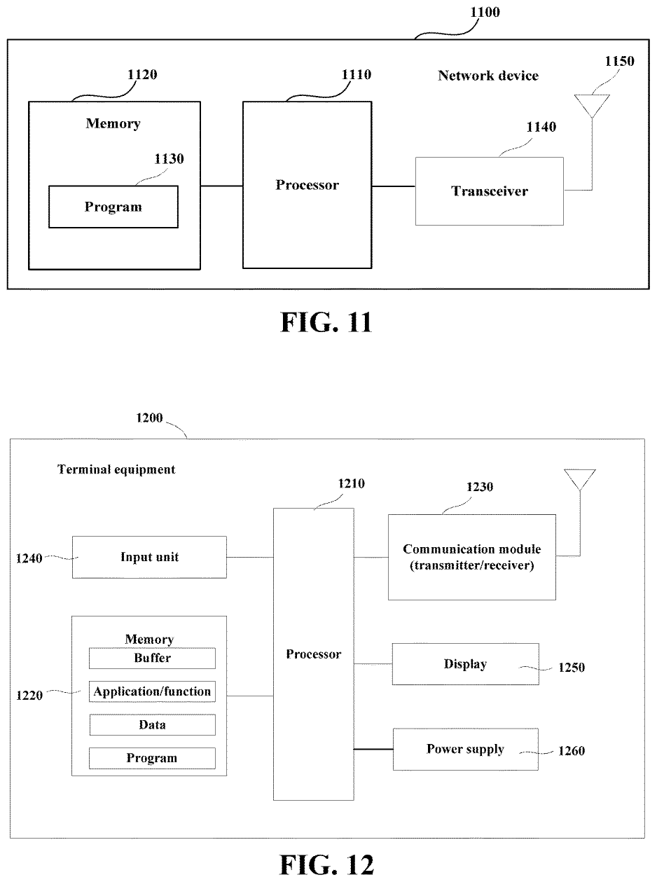

As shown in FIG. 11, a network may configure a release of LTM configuration, and a terminal equipment attempts to execute CHO based on a network configuration.

Table 12 exemplarily shows another example, but the present disclosure is not limited thereto. For example, “upon CHO execution is performed” may be replaced with “an RLF is triggered”, “T304 expires”, “RRC reestablishment is initiated”, etc.

TABLE 12
- ConditionalReconfiguration
The IE ConditionalReconfiguration is used to add, modify and release the configuration of
conditional reconfiguration.

ConditionalReconfiguration information element

-- ASN1START
-- TAG-CONDITIONALRECONFIGURATION-START

| | |
|---|---|
| ConditionalReconfiguration-r16 ::= | SEQUENCE { |
| attemptCondReconfig-r16 | ENUMERATED {true} |

OPTIONAL, -- Cond CHO

| | |
|---|---|
| releaseForattemptLTM ENUMERATED {true} | OPTIONAL, -- Cond |

attempCHO

| | |
|---|---|
| condReconfigToRemoveList-r16 | CondReconfigToRemoveList-r16 OPTIONAL, |

-- Need N

| | |
|---|---|
| condReconfigToAddModList-r16 | CondReconfigToAddModList-r16 |

OPTIONAL, -- Need N
...
}

| | |
|---|---|
| CondReconfigToRemoveList-r16 ::= | SEQUENCE (SIZE (1.. maxNrofCondCells-r16)) |

OF CondReconfigId-r16
-- TAG-CONDITIONALRECONFIGURATION-STOP
-- ASN1STOP

releaseForattemptLTM
(Used to enable LTM execution after RLF or HOF.) If this field is present,
ConditionalReconfiguration for MCG is released by the UE upon LTM execution is
performed.

As shown in FIG. 12, a network may configure a release of CHO configuration, and a terminal equipment attempts to execute LTM based on a network configuration.

Thus, when a cell is both an LTM candidate and a CHO candidate, LTM execution or CHO execution is attempted according to a configuration of a network device, a terminal equipment is able to perform fast failure recovery, thereby reducing service interruption time and improving user experience. Furthermore, a terminal behavior is deterministic and controlled by a network. Compared to solutions based on implementation of a terminal equipment, the number of tests for a terminal equipment is reduced, thereby lowering the cost of a terminal equipment.

Each of the above embodiments only exemplarily describes the present disclosure, but the present disclosure is not limited thereto, appropriate modifications may be further made based on each of the above embodiments. For example, each of the above embodiments may be used individually, or one or more of the above embodiments may be combined.

As may be known from the above embodiments, through embodiments of the present disclosure, by attempting to execute CHO or LTM according to regulations or based on implementation of a terminal equipment or according to a configuration of a network device, a terminal equipment is able to perform fast failure recovery, thereby reducing service interruption time and improving user experience.

### Embodiments of a Third Aspect

Embodiments of the present disclosure provide a method for configuring candidate cell(s), which is described from a network device side. Embodiments of the third aspect may be combined with embodiments of the first and second aspects, and contents same as those in embodiments of the first and second aspects are not further elaborated.

FIG. 8 is a schematic diagram of a method for configuring candidate cell(s) in embodiments of the present disclosure, as shown in FIG. 8, the method includes:
801, a network device transmits configuration information for configuring candidate cell(s) to a terminal equipment;
wherein one cell is not simultaneously configured as a Conditional Handover (CHO) candidate cell and an L1/L2 Triggered Mobility (LTM) candidate cell of the terminal equipment, or, the terminal equipment attempts to execute CHO or LTM according to a configuration of the network device.

It is worth noting that the above FIG. 8 only schematically describes embodiments of the present disclosure, however the present disclosure is not limited thereto. For example, an execution sequence of each operation may be adjusted appropriately, moreover some other operations may be increased or certain operations therein may be further removed. Persons skilled in the art may make appropriate modifications according to the above contents, not being limited to records in the above FIG. 8.

In some embodiments, a terminal equipment does not support CHO and LTM simultaneously.

A network device receives a measurement report message from a terminal equipment and decides to initiate LTM configuration.

Or, a network device receives a measurement report message from a terminal equipment, and if the terminal equipment is configured with conditional reconfiguration, a network device decides not to initiate LTM configuration. Or, a network device releases conditional reconfiguration and decides to initiate LTM configuration.

In a case where a network device decides to initiate LTM configuration, the network device transmits LTM configuration to a terminal equipment.

For example, the network device is a gNB.

For another example, in case of CU-DU split, a gNB-CU decides to initiate LTM configuration. A gNB-CU transmits a UE CONTEXT MODIFICATION REQUEST message including a target candidate cell ID to a (source/serving) gNB-DU (where a serving cell of a terminal equipment is located). If the gNB-DU accepts a request for LTM configuration, the gNB-DU responds with one UE CONTEXT MODIFICATION RESPONSE message including generated lower layer RRC configuration of the accepted target candidate cell. A gNB-CU transmits a DL RRC MESSAGE TRANSFER message to the gNB-DU, including a generated RRCReconfiguration message carrying LTM configuration. The gNB-DU forwards the received RRCReconfiguration message to a terminal equipment.

Or, a gNB-CU transmits a UE CONTEXT SETUP REQUEST message including a target candidate cell ID to a (candidate) gNB-DU. If the (candidate) gNB-DU accepts a request for LTM configuration, the (candidate) gNB-DU responds with one UE CONTEXT SETUP RESPONSE message including generated lower layer RRC configuration and RS configuration of the accepted target candidate cell. A gNB-CU transmits a UE CONTEXT MODIFICATION REQUEST message including RS configuration, TCI state configuration, and RACH configuration of acceptable target candidate cells in other collected gNB-DUs to a (source/serving) gNB-DU (where a serving cell of a terminal equipment is located). The source gNB-DU responds with one UE CONTEXT MODIFICATION RESPONSE message. A gNB-CU transmits a UE CONTEXT SETUP REQUEST message including a cell ID of a prepared candidate cell and associated RS configuration for each candidate cell in other candidate gNB-DUs to a (candidate) gNB-DU. The (candidate) gNB-DU responds with one UE CONTEXT SETUP RESPONSE message including updated lower layer RRC configuration. A gNB-CU transmits a DL RRC MESSAGE TRANSFER message including a generated RRCReconfiguration message carrying LTM configuration to the source gNB-DU. The source gNB-DU forwards the received RRCReconfiguration message to a terminal equipment.

In some embodiments, a terminal equipment does not support CHO and LTM simultaneously.

A network device receives a measurement report message from a terminal equipment, and the network device transmits CHO configuration to a terminal equipment.

Or, a network device receives a measurement report message from a terminal equipment, and if the terminal equipment is configured with LTM, the network device does not transmit CHO configuration to a terminal equipment. Or, a network device releases LTM configuration and transmits CHO configuration to a terminal equipment.

For example, the network device is a gNB.

For another example, in case of CU-DU split, a gNB-CU decides to initiate CHO configuration. A gNB-CU transmits a UE CONTEXT SETUP REQUEST message to a candidate gNB-DU to create a UE context and establish one or more data bearers. The candidate gNB-DU responds to the gNB-CU with one UE CONTEXT SETUP RESPONSE message including a target cell ID requested by the gNB-CU. The gNB-CU transmits a DL RRC MESSAGE TRANSFER message including a generated RRCReconfiguration message to the source gNB-DU. The source gNB-DU forwards the received RRCReconfiguration message to a terminal equipment.

In some embodiments, if the network device configures CHO or conditional reconfiguration (ConditionalReconfig) of an MCG for the terminal equipment, the network device does not configure LTM or LTM-Config or LTM-Candidate; and/or, if the network device configures LTM or LTM-Config or LTM-Candidate for the terminal equipment, the network device does not configure CHO or conditional reconfiguration (ConditionalReconfig) of an MCG.

In some embodiments, the terminal equipment supports CHO and LTM simultaneously; a first cell configured by the network device for the terminal equipment is a CHO candidate cell, a second cell thereof is an LTM candidate cell, and the first cell and the second cell are different cells.

In some embodiments, the network device does not configure the first cell as an LTM candidate cell, and the network device does not configure the second cell as a CHO candidate cell.

In some embodiments, the network device is a gNB, or a gNB-CU of a serving cell, or a gNB-CU of a source cell, or a gNB-DU of a candidate cell.

In some embodiments, the network device configures a first value for a timer T304 or a first timer, the first value being applicable to random access-based LTM and non-random access LTM;
or,
the network device configures a second value and a third value for the timer T304 or the first timer, the second value being applicable to random access-based LTM, and the third value being applicable to non-random access LTM.

In some embodiments, a configuration of the network device includes that: the network device configures CHO first; and/or, the network device configures attemptCondReconfig but does not configure attemptLTM-Switch; and/or, the network device configures a release of LTM configuration.

In some embodiments, a configuration of the network device includes that: the network device configures LTM first; and/or, the network device configures attemptLTM-Switch but does not configure attemptCondReconfig; and/or, the network device configures a release of CHO configuration.

Each of the above embodiments only exemplarily describes the present disclosure, but the present disclosure is not limited thereto, appropriate modifications may be further made based on each of the above embodiments. For example, each of the above embodiments may be used individually, or one or more of the above embodiments may be combined.

As may be known from the above embodiments, through embodiments of the present disclosure, one cell is not simultaneously configured as a CHO candidate cell and an LTM candidate cell, or by attempting to execute CHO or LTM according to a configuration of a network device, a terminal equipment is able to perform fast failure recovery, thereby reducing service interruption time and improving user experience.

### Embodiments of a Fourth Aspect

Embodiments of the present disclosure provide a configuring method, which is described from a network device side. Embodiments of the fourth aspect may be performed independently, or may be combined with embodiments of the first to third aspects, and contents same as those in embodiments of the first to third aspects are not further elaborated.

In some embodiments, a network device configures a first value for a timer T304 or a first timer, the first value being applicable to random access-based LTM and non-random access LTM.

In some embodiments, a network device configures a second value and a third value for the timer T304 or the first timer, the second value being applicable to random access-based LTM, and the third value being applicable to non-random access LTM.

In some embodiments, a first timer may be a timer different from a timer T304. A first timer may be configured independently of T304. For example, a first timer is configured with a first value, and T304 is also configured with a first value; or a first timer is configured with a first value, and T304 is configured with a second value or a third value, and so on.

In some embodiments, a first timer may be configured in association with T304. For example, if a first timer is configured with a first value, T304 is also configured with a first value; or if a first timer is configured with a second value, T304 is configured with a third value, and so on.

For example, a terminal equipment releases LTM configuration when at least one of the following events occurs: handover (L3 HO/CHO/LTM) execution (e.g., T304 start/running), radio link failure trigger and/or handover failure (e.g., T304 expires), or initiation of an RRC connection re-establishment procedure (e.g., T311 start/running).

For another example, a terminal equipment releases CHO configuration when at least one of the following events occurs: handover (L3 HO/CHO/LTM) execution, radio link failure trigger and/or handover failure (T304 expires), or initiation of an RRC connection re-establishment procedure.

In some embodiments, in case of LTM cell switch execution, the timer T304 is started, or in case of LTM cell switch execution, the first timer is started.

In some embodiments, when a timer T304 or a first timer expires, it is considered that a handover fails.

Each of the above embodiments only exemplarily describes the present disclosure, but the present disclosure is not limited thereto, appropriate modifications may be further made based on each of the above embodiments. For example, each of the above embodiments may be used individually, or one or more of the above embodiments may be combined.

### Embodiments of a Fifth Aspect

Embodiments of the present disclosure provide an apparatus for configuring candidate cell(s) or an apparatus for applying candidate cell(s). The apparatus e.g. may be a terminal equipment, or may be certain component(s) or assembly/assemblies configured in a terminal equipment. Contents same as those in embodiments of the first to third aspects are not further elaborated.

FIG. 9 is a schematic diagram of an apparatus for configuring or applying candidate cell(s) in embodiments of the present disclosure. As shown in FIG. 9, an apparatus 900 for configuring or applying candidate cell(s) includes: a receiving unit 901 and a processing unit 902.

In some embodiments, the receiving unit 901 receives configuration information for configuring candidate cell(s) transmitted by a network device, wherein one cell is not simultaneously configured as a Conditional Handover (CHO) candidate cell and an L1/L2 Triggered Mobility (LTM) candidate cell of the terminal equipment.

In some embodiments, a terminal equipment does not support CHO and LTM simultaneously;
if the terminal equipment is configured with CHO or conditional reconfiguration (ConditionalReconfig) of an MCG, the terminal equipment is not configured with LTM or LTM-Config or LTM-Candidate; and/or
if the terminal equipment is configured with LTM or LTM-Config or LTM-Candidate, the terminal equipment is not configured with CHO or conditional reconfiguration (ConditionalReconfig) of an MCG.

In some embodiments, a terminal equipment supports CHO and LTM simultaneously;
a first cell of the terminal equipment is a CHO candidate cell, a second cell thereof is an LTM candidate cell, and the first cell and the second cell are different cells.

In some embodiments, the first cell is not configured as an LTM candidate cell by a network device, and the second cell is not configured as a CHO candidate cell by a network device.

In some embodiments, the network device is a gNB, or a gNB-CU of a serving cell, or a gNB-CU of a source cell, or a gNB-DU of a candidate cell.

In some embodiments, if the first cell is further configured as an LTM candidate cell by a network device, or if the second cell is further configured as a CHO candidate cell by a network device, the terminal equipment releases LTM configuration or CHO configuration when performing handover or when a radio link failure is triggered or in case of a handover failure or when an RRC connection reestablishment procedure is initiated.

In some embodiments, the handover failure includes that a timer T304 or a first timer expires, the first timer being different from the timer T304;

in case of LTM cell switch execution, the timer T304 is started, or in case of LTM cell switch execution, the first timer is started.

In some embodiments, the timer T304 or the first timer is configured with a first value applicable to random access-based LTM and non-random access LTM; or
the timer T304 or the first timer is configured with a second value and a third value, the second value being applicable to random access-based LTM, and the third value being applicable to non-random access LTM.

In some embodiments, the processing unit 902 initiates RRC connection reestablishment after a radio link failure; wherein,
if a cell selected in cell selection is a CHO candidate cell, the terminal equipment attempts to execute CHO; if a cell selected in the cell selection is an LTM candidate cell, the terminal equipment attempts to execute LTM;
wherein the radio link failure includes: an RLF of a source cell when CHO is configured, or an RLF when LTM is configured, or an RLF of a source cell when LTM is configured, or an RLF of a target cell when LTM is configured.

In some embodiments, the processing unit 902 initiates RRC connection reestablishment after an LTM failure; wherein,
if a cell selected in cell selection is a CHO candidate cell, the terminal equipment attempts to execute CHO; if a cell selected in the cell selection is an LTM candidate cell, the terminal equipment attempts to execute LTM;
or, if a cell selected in cell selection is an LTM candidate cell, the terminal equipment attempts to execute LTM; otherwise, the terminal equipment transmits an RRC reestablishment request.

In some embodiments, the processing unit 902 initiates RRC connection reestablishment after a handover failure; wherein,
if a cell selected in cell selection is a CHO candidate cell, the terminal equipment attempts to execute CHO; if a cell selected in the cell selection is an LTM candidate cell, the terminal equipment attempts to execute LTM;
or, if a cell selected in cell selection is a CHO candidate cell, the terminal equipment attempts to execute CHO; otherwise, the terminal equipment transmits an RRC reestablishment request.

In some embodiments, the handover includes at least one of the following:
reconfiguration with synchronization;
reconfiguration with L3 synchronization;
reconfiguration with L3 synchronization of an MCG, triggered by a network;
reconfiguration with conditional synchronization of an MCG;
reconfiguration with conditional synchronization of an MCG including reconfiguration with conditional synchronization of an SCG; or
L1/L2 Triggered Mobility (LTM) of an MCG.

In some embodiments, the receiving unit 901 receives configuration information for configuring candidate cell(s) transmitted by a network device; and a processing unit 902 attempts to execute CHO or LTM according to regulations or based on implementation of a terminal equipment or according to a configuration of a network device.

In some embodiments, the processing unit 902 is further used to: initiate RRC connection reestablishment after a radio link failure or a handover failure; perform cell selection; and according to a selected cell, attempt to execute CHO or LTM according to regulations or based on implementation of a terminal equipment or according to a configuration of a network device.

In some embodiments, the radio link failure includes: an RLF of a source cell when CHO is configured, or an RLF when LTM is configured, or an RLF of a source cell when LTM is configured, or an RLF of a target cell when LTM is configured;
the handover includes at least one of the following:
reconfiguration with synchronization;
reconfiguration with L3 synchronization;
reconfiguration with L3 synchronization of an MCG, triggered by a network;
reconfiguration with conditional synchronization of an MCG;
reconfiguration with conditional synchronization of an MCG including reconfiguration with conditional synchronization of an SCG; or
L1/L2 Triggered Mobility (LTM) of an MCG.

In some embodiments, the processing unit 902 attempts to execute CHO or LTM according to regulations includes: if a cell selected in cell selection is an LTM candidate cell, the terminal equipment attempts to execute LTM; otherwise, if a cell selected in cell selection is a CHO candidate cell, the terminal equipment attempts to execute CHO; otherwise, the terminal equipment transmits an RRC reestablishment request.

In some embodiments, the processing unit 902 attempts to execute LTM based on implementation of a terminal equipment includes: if LTM execution does not include RLC reestablishment and/or PDCP data recovery, attempts to execute LTM; and/or, if an LTM configuration includes a Contention-Free Random Access (CFRA) configuration, attempts to execute LTM.

In some embodiments, the processing unit 902 attempts to execute CHO based on implementation of a terminal equipment includes: if LTM execution includes RLC reestablishment and/or PDCP data recovery, attempts to execute CHO; and/or, if an LTM configuration does not include a Contention-Free Random Access (CFRA) configuration, attempts to execute CHO.

In some embodiments, the processing unit 902 attempts to execute CHO according to a configuration of a network device, CHO is configured by a network device first; and/or, a network device configures attemptCondReconfig but does not configure attemptLTM-Switch; and/or, an LTM configuration is released by a network device.

In some embodiments, the processing unit 902 attempts to execute LTM according to a configuration of a network device, LTM is configured by a network device first; and/or, a network device configures attemptLTM-Switch but does not configure attemptCondReconfig; and/or, a CHO configuration is released by a network device.

It is worth noting that the above text only describes components or modules related to the present disclosure, however the present disclosure is not limited thereto. Apparatus 900 for configuring or applying candidate cell(s) may further include other components or modules. For detailed contents of these components or modules, relevant technologies may be referred to.

Moreover, for the sake of simplicity, FIG. 9 only exemplarily shows a connection relationship or signal flow between components or modules, however persons skilled in the art should know that various relevant technologies such as bus connection may be used. Each of the above components or modules may be implemented via a hardware facility such as a processor, a memory, a transmitter, a receiver, etc. Embodiments of the present disclosure do not impose limitations thereto.

Through embodiments of the present disclosure, one cell is not simultaneously configured as a CHO candidate cell and an LTM candidate cell, or by attempting to execute CHO or LTM according to a configuration of a network device, a terminal equipment is able to perform fast failure recovery, thereby reducing service interruption time and improving user experience.

### Embodiments of a Sixth Aspect

Embodiments of the present disclosure provide an apparatus for configuring candidate cell(s).

The apparatus e.g. may be a network device, or may be certain component(s) or assembly/assemblies configured in a network device. Contents same as those in embodiments of the first to fourth aspects are not further elaborated.

FIG. 10 is a schematic diagram of an apparatus for configuring candidate cell(s) in embodiments of the present disclosure. As shown in FIG. 10, an apparatus 1000 for configuring candidate cell(s) includes:
a transmitting unit 1001 configured to transmit configuration information for configuring candidate cell(s) to a terminal equipment;
wherein one cell is not simultaneously configured as a Conditional Handover (CHO) candidate cell and an L1/L2 Triggered Mobility (LTM) candidate cell of the terminal equipment, or, the terminal equipment attempts to execute CHO or LTM according to a configuration of the network device.

In some embodiments, a terminal equipment does not support CHO and LTM simultaneously;
if the network device configures CHO or conditional reconfiguration (ConditionalReconfig) of an MCG for the terminal equipment, the network device does not configure LTM or LTM-Config or LTM-Candidate; and/or
if the network device configures LTM or LTM-Config or LTM-Candidate for the terminal equipment, the network device does not configure CHO or conditional reconfiguration (ConditionalReconfig) of an MCG.

In some embodiments, a terminal equipment supports CHO and LTM simultaneously;
a first cell configured by the network device for the terminal equipment is a CHO candidate cell, a second cell thereof is an LTM candidate cell, and the first cell and the second cell are different cells;
the network device does not configure the first cell as an LTM candidate cell, and the network device does not configure the second cell as a CHO candidate cell.

In some embodiments, the network device is a gNB, or a gNB-CU of a serving cell, or a gNB-CU of a source cell, or a gNB-DU of a candidate cell.

In some embodiments, the network device configures a first value for a timer T304 or a first timer, the first value being applicable to random access-based LTM and non-random access LTM;
or,
the network device configures a second value and a third value for the timer T304 or the first timer, the second value being applicable to random access-based LTM, and the third value being applicable to non-random access LTM.

In some embodiments, a configuration of the network device includes that:
the network device configures CHO first; and/or, the network device configures attemptCondReconfig but does not configure attemptLTM-Switch; and/or, the network device configures a release of LTM configuration.

In some embodiments, a configuration of the network device includes that:
the network device configures LTM first; and/or, the network device configures attemptLTM-Switch but does not configure attemptCondReconfig; and/or, the network device configures a release of CHO configuration.

It is worth noting that the above text only describes components or modules related to the present disclosure, however the present disclosure is not limited thereto. Apparatus 1000 for configuring candidate cell(s) may further include other components or modules. For detailed contents of these components or modules, relevant technologies may be referred to.

Moreover, for the sake of simplicity, FIG. 10 only exemplarily shows a connection relationship or signal flow between components or modules, however persons skilled in the art should know that various relevant technologies such as bus connection may be used. Each of the above components or modules may be implemented via a hardware facility such as a processor, a memory, a transmitter, a receiver, etc. Embodiments of the present disclosure do not impose limitations thereto.

Through embodiments of the present disclosure, one cell is not simultaneously configured as a CHO candidate cell and an LTM candidate cell, or by attempting to execute CHO or LTM according to a configuration of a network device, a terminal equipment is able to perform fast failure recovery, thereby reducing service interruption time and improving user experience.

### Embodiments of a Seventh Aspect

Embodiments of the present disclosure further provide a communication system, FIG. 2 may be referred to, contents same as those in embodiments of the first to sixth aspects are not further elaborated.

In some embodiments, a communication system 100 at least may include:
a network device configured to transmit configuration information for configuring candidate cell(s) to a terminal equipment; and
a terminal equipment configured to receive the configuration information; wherein one cell is not simultaneously configured as a Conditional Handover (CHO) candidate cell and an L1/L2 Triggered Mobility (LTM) candidate cell of the terminal equipment, or, the terminal equipment attempts to execute CHO or LTM according to a configuration of the network device.

Embodiments of the present disclosure further provide a network device, for example may be a base station, but the present disclosure is not limited thereto, or may further be other network device.

FIG. 11 is a composition schematic diagram of a network device in embodiments of the present disclosure. As shown in FIG. 11, a network device 1100 may include: a processor 1110 (such as a central processing unit (CPU)), and a memory 1120 coupled to the processor 1110. The memory 1120 may store various data; moreover, further stores a program 1130 for information processing, and executes the program 1130 under the control of the processor 1110.

For example, the processor 1110 may be configured to execute a program to implement a method for configuring candidate cell(s) as described in embodiments of the third aspect. For example, the processor 1110 may be configured to perform the following control: transmitting configuration information for configuring candidate cell(s) to a terminal equipment; wherein one cell is not simultaneously configured as a Conditional Handover (CHO) candidate cell and an L1/L2 Triggered Mobility (LTM) candidate cell of the terminal equipment, or, the terminal equipment attempts to execute CHO or LTM according to a configuration of the network device.

In addition, as shown in FIG. 11, a network device 1100 may further include a transceiver 1140 and an antenna 1150, etc., wherein functions of said components are similar to related arts and are not further elaborated here. It is worth noting that the network device 1100 does not have to include all components shown in FIG. 11. Moreover, the network device 1100 may further include components not shown in FIG. 11, related arts may be referred to.

Embodiments of the present disclosure further provide a terminal equipment, but the present disclosure is not limited thereto, it may also be other device.

FIG. 12 is a schematic diagram of a terminal equipment in embodiments of the present disclosure. As shown in FIG. 12, the terminal equipment 1200 may include a processor 1210, and a memory 1220 configured to store data and programs and be coupled to the processor 1210. It is worth noting that this figure is exemplary, other types of structures may also be used to supplement or replace this structure, so as to implement a telecommunication function or other functions.

For example, a processor 1210 may be configured to execute a program to implement a method for configuring candidate cell(s) as described in embodiments of the first aspect. For example, a processor 1210 may be configured to perform the following control: receiving configuration information for configuring candidate cell(s) transmitted by a network device, wherein one cell is not simultaneously configured as a Conditional Handover (CHO) candidate cell and an L1/L2 Triggered Mobility (LTM) candidate cell of the terminal equipment.

For another example, a processor 1210 may be configured to execute a program to implement a method for applying candidate cell(s) as described in embodiments of the second aspect. For example, a processor 1210 may be configured to perform the following control: receiving configuration information for configuring candidate cell(s) transmitted by a network device; and attempting to execute CHO or LTM according to regulations or based on implementation of a terminal equipment or according to a configuration of a network device.

As shown in FIG. 12, the terminal equipment 1200 may further include: a communication module 1230, an input unit 1240, a display 1250, and a power supply 1260. Functions of the above components are similar to related arts, and are not further elaborated here. It is worth noting that the terminal equipment 1200 does not have to include all components shown in FIG. 12, said components are not indispensable. Moreover, the terminal equipment 1200 may further include components not shown in FIG. 12, related arts may be referred to.

Embodiments of the present disclosure further provide a computer program, wherein when the program is executed in a terminal equipment, the program enables the terminal equipment to execute a method for configuring candidate cell(s) as described in embodiments of the first aspect or a method for applying candidate cell(s) as described in embodiments of the second aspect.

Embodiments of the present disclosure further provide a storage medium in which a computer program is stored, wherein the computer program enables a terminal equipment to execute a method for configuring candidate cell(s) as described in embodiments of the first aspect or a method for applying candidate cell(s) as described in embodiments of the second aspect.

Embodiments of the present disclosure further provide a computer program, wherein when the program is executed in a network device, the program enables the terminal equipment to execute a method for configuring candidate cell(s) as described in embodiments of the third aspect.

Embodiments of the present disclosure further provide a storage medium in which a computer program is stored, wherein the computer program enables a network device to execute a method for configuring candidate cell(s) as described in embodiments of the third aspect.

Apparatuses and methods in the present disclosure may be implemented by hardware, or may be implemented by combining hardware with software. The present disclosure relates to such a computer readable program, when the program is executed by a logic component, the logic component is able to implement the apparatuses described in the above text or a constituent component, or the logic component is able to implement various methods or steps described in the above text. The present disclosure further relates to a storage medium storing said programs, such as a hard disk, a magnetic disk, an optical disk, a DVD, a flash memory and the like.

Methods/apparatuses described by combining with embodiments of the present disclosure may be directly embodied as hardware, a software module executed by a processor, or a combination of the two. For example, one or more of functional block diagrams as shown in the drawings or one or more combinations of functional block diagrams may correspond to software modules of a computer program process, or may correspond to hardware modules. These software modules may respectively correspond to steps shown in the drawings. These hardware modules may be implemented by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM, or a storage medium in any other form as known in the art. A storage medium may be coupled to a processor, thus enabling the processor to read information from the storage medium and write information into the storage medium, or the storage medium may be a constituent part of a processor. A processor and a storage medium may be located in an ASIC. The software module may be stored in a memory of a mobile terminal, or may be stored in a memory card that may be inserted into a mobile terminal. For example, if a device (e.g., a mobile terminal) adopts a MEGA-SIM card with a larger capacity or a flash memory apparatus with a large capacity, the software module may be stored in the MEGA-SIM card, or in the flash memory apparatus with a large capacity.

One or more of functional block diagrams described in the drawings or one or more combinations of functional block diagrams may be implemented as a general-purpose processor for performing functions described in the present disclosure, a digital signal processor (DSP), an application-specific integrated circuit (ASIC), a field-programmable gate array (FPGA) or other programmable logic device, a discrete gate or a transistor logic device, a discrete hardware component, or any appropriate combination thereof. One or more of functional block diagrams described in the drawings or one or more combinations of functional block diagrams may further be implemented as a combination of computing devices, such as a combination of a DSP and a microprocessor, a plurality of microprocessors, one or more microprocessors combined and communicating with a DSP, or any other such configuration.

The present disclosure is described above by combining with specific implementations, however persons skilled in the art should clearly know that these descriptions are exemplary and do not limit a protection scope of the present disclosure. Persons skilled in the art may make various variations and amendments to the present disclosure according to principles of the present disclosure, these variations and amendments are also within a scope of the present disclosure.

As for implementations including the above embodiments, the following supplements are further disclosed:
1. A method for configuring candidate cell(s), including that:
a terminal equipment receives configuration information for configuring candidate cell(s) transmitted by a network device;
wherein one cell is not simultaneously configured as a Conditional Handover (CHO) candidate cell and an L1/L2 Triggered Mobility (LTM) candidate cell of the terminal equipment.
2. A method for applying candidate cell(s), including that:
a terminal equipment receives configuration information for configuring candidate cell(s) transmitted by a network device; and
the terminal equipment attempts to execute CHO or LTM according to regulations or based on implementation of a terminal equipment or according to a configuration of a network device.
3. The method according to supplement 2, wherein the method further includes:
initiating RRC connection reestablishment after a radio link failure or a handover failure; performing cell selection; and
according to a selected cell, attempting to execute CHO or LTM according to regulations or based on implementation of a terminal equipment or according to a configuration of a network device.
4. The method according to supplement 3, wherein the radio link failure includes: an RLF of a source cell when CHO is configured, or an RLF when LTM is configured, or an RLF of a source cell when LTM is configured, or an RLF of a target cell when LTM is configured;
the handover includes at least one of the following:
reconfiguration with synchronization;
reconfiguration with L3 synchronization;
reconfiguration with L3 synchronization of an MCG, triggered by a network;
reconfiguration with conditional synchronization of an MCG;
reconfiguration with conditional synchronization of an MCG including reconfiguration with conditional synchronization of an SCG; or
L1/L2 Triggered Mobility (LTM) of an MCG.
5. The method according to supplement 2, wherein the terminal equipment attempts to execute CHO or LTM according to regulations includes:
if a cell selected in cell selection is an LTM candidate cell, the terminal equipment attempts to execute LTM;
otherwise, if a cell selected in cell selection is a CHO candidate cell, the terminal equipment attempts to execute CHO;
otherwise, the terminal equipment transmits an RRC reestablishment request.
6. The method according to supplement 2, wherein a terminal equipment attempts to execute LTM based on implementation of the terminal equipment includes:
if LTM execution does not include RLC reestablishment and/or PDCP data recovery, attempting to execute LTM; and/or, if an LTM configuration includes a Contention-Free Random Access (CFRA) configuration, attempting to execute LTM.
7. The method according to supplement 2, wherein a terminal equipment attempts to execute CHO based on implementation of the terminal equipment includes:
if LTM execution includes RLC reestablishment and/or PDCP data recovery, attempting to execute CHO; and/or, if an LTM configuration does not include a Contention-Free Random Access (CFRA) configuration, attempting to execute CHO.
8. The method according to supplement 2, wherein the terminal equipment attempts to execute CHO according to a configuration of a network device, CHO is configured by a network device first; and/or, a network device configures attemptCondReconfig but does not configure attemptLTM-Switch; and/or, an LTM configuration is released by a network device;
or, the terminal equipment attempts to execute LTM according to a configuration of a network device, LTM is configured by a network device first; and/or, a network device configures attemptLTM-Switch but does not configure attemptCondReconfig; and/or, a CHO configuration is released by a network device.
9. A method for configuring candidate cell(s), including that:
a network device transmits configuration information for configuring candidate cell(s) to a terminal equipment;
wherein one cell is not simultaneously configured as a Conditional Handover (CHO) candidate cell and an L1/L2 Triggered Mobility (LTM) candidate cell of the terminal equipment, or, the terminal equipment attempts to execute CHO or LTM according to a configuration of the network device.
10. A communication system, including:
a network device configured to transmit configuration information for configuring candidate cell(s) to a terminal equipment; and
a terminal equipment configured to receive the configuration information; wherein one cell is not simultaneously configured as a Conditional Handover (CHO) candidate cell and an L1/L2 Triggered Mobility (LTM) candidate cell, or, the terminal equipment attempts to execute CHO or LTM according to a configuration of the network device.

What is claimed is:

1. An apparatus for applying candidate cell, configured in a terminal equipment, the apparatus comprising:
a receiver configured to receive configuration information for configuring candidate cell(s) transmitted by a network device; and
a processor circuitry configured to attempt to execute CHO (Conditional Handover) or LTM (L1/L2 Triggered Mobility) based on implementation of the terminal equipment or according to a configuration of the network device when the terminal equipment is configured with CHO configuration and LTM configuration.

2. The apparatus according to claim 1, wherein the processor circuitry is configured to:
initiate radio resource control connection reestablishment after a radio link failure or a handover failure;
perform cell selection; and
according to a selected cell, attempt to execute CHO or LTM based on implementation of the terminal equipment or according to the configuration of the network device.

3. The apparatus according to claim 1, wherein the terminal equipment attempts to execute CHO or LTM based on implementation of the terminal equipment or according to a configuration of the network device, comprises:
if a cell selected in a cell selection is an LTM candidate cell, the terminal equipment attempts to execute the LTM; otherwise, the terminal equipment transmits a radio resource control reestablishment request.

4. The apparatus according to claim 1, wherein the terminal equipment attempts to execute CHO or LTM based on implementation of the terminal equipment or according to a configuration of the network device, comprises:
if a cell selected in a cell selection is a CHO candidate cell, the terminal equipment attempts to execute the CHO; otherwise, the terminal equipment transmits a RRC reestablishment request.

5. The apparatus according to claim 4, wherein the terminal equipment attempts to execute CHO after a handover failure, and the handover comprises at least one of the following:
reconfiguration with synchronization;
reconfiguration with L3 synchronization;
reconfiguration with L3 synchronization of an MCG (Master Cell Group), triggered by a network;
reconfiguration with conditional synchronization of an MCG;
reconfiguration with conditional synchronization of an MCG including reconfiguration with conditional synchronization of a SCG (Secondary Cell Group); or
L1/L2 triggered mobility of an MCG.

6. The apparatus according to claim 2, wherein the terminal equipment releases LTM configuration and/or CHO configuration when the radio resource control connection reestablishment is initiated.

7. The apparatus according to claim 6, wherein initiating the radio resource control connection reestablishment comprises: a timer T311 is started or is running.

8. The apparatus according to claim 3, wherein the terminal equipment attempts to execute CHO or LTM based on implementation of the terminal equipment or according to a configuration of the network device, comprises:
if a suitable cell is not found within a certain time after a radio link failure, the terminal equipment enters an idle state.

9. The apparatus according to claim 4, wherein the terminal equipment attempts to execute CHO or LTM based on implementation of the terminal equipment or according to a configuration of the network device, comprises:
if a suitable cell is not found within a certain time after a radio link failure, the terminal equipment enters an idle state.

10. An apparatus for configuring candidate cell, configured in a network device, the apparatus comprising:
a transmitter configured to transmit configuration information for configuring candidate cell(s) to a terminal equipment;
wherein the terminal equipment attempts to execute CHO or LTM based on implementation of the terminal equipment or according to a configuration of the network device when the terminal equipment is configured with CHO configuration and LTM configuration.

11. A communication system, comprising:
a network device configured to transmit configuration information for configuring candidate cell(s); and
a terminal equipment configured to attempt to execute CHO or LTM based on implementation of the terminal equipment or according to a configuration of the network device when the terminal equipment is configured with CHO configuration and LTM configuration.
